(19) United States
(12) Patent Application Publication
(10) Pub. No.: US 2025/0270807 A1
(43) Pub. Date: Aug. 28, 2025

(54) BUILDING PANEL

(71) Applicant: ARMSTRONG WORLD INDUSTRIES, INC., Lancaster, PA (US)

(72) Inventors: Charles G. KRICK, Lititz, PA (US); Gourish SIRDESHPANDE, Lancaster, PA (US); Jacob D. PETERSON, Aliquippa, PA (US)

(21) Appl. No.: 18/866,718

(22) PCT Filed: May 15, 2023
(86) PCT No.: PCT/US2023/022268

§ 371 Date: Nov. 18, 2024

Related U.S. Application Data
(60) Provisional application No. 63/342,229, filed on May 16, 2022.

(51) Int. Cl. E04B 1/90; C04B 14/02; C04B 14/46; C04B 38/00; C04B 103/63; C04B 111/28; C04B 111/52

(52) U.S. Cl. CPC E04B 1/90; C04B 14/022; C04B 14/46; C04B 38/0067; C04B 2103/63; C04B 2111/28; C04B 2111/52

(57) ABSTRACT

Described herein is a building panel having a body including an inorganic material in an amount ranging from about 1 wt. % to about 99 wt. % based on the total weight of the body and biochar in an amount ranging from about 1 wt. % to about 40 wt. % based on the total weight of the body. In some embodiments, the inorganic material may include inorganic fibers. In some embodiments, the inorganic material may include inorganic particles. In some embodiments, the building panel may further include a flame retardant in an amount ranging from about 1 wt. % to about 15 wt. % based on the total weight of the body.

### CROSS-REFERENCE TO RELATED APPLICATIONS

This application is a U.S. Non-Provisional application claiming priority to PCT International Application No. PCT/US2023/022268, filed on May 15, 2023, claiming priority to U.S. Provisional Patent Application No. 63/342,229, filed on May 16, 2022, the disclosures of which are incorporated herein by reference in its entirety.

### BACKGROUND

Carbon dioxide (CO₂) emissions₂ have been identified as a major contributor to the phenomenon of global warming and ocean acidification. CO₂ is a by-product of combustion, and it creates operational, economic, and environmental problems. It is expected that elevated atmospheric concentrations of CO₂ and other greenhouse gases will facilitate greater storage of heat within the atmosphere leading to enhanced surface temperatures and rapid climate change. Building products and the materials used to form such building products are a contributor to CO₂ emissions. Therefore, a need exists for new building products that help reduce or eliminate CO₂ emissions. Furthermore, such new building products should be developed without sacrifice of mechanical and/or acoustic performance characteristics necessary for such building products to function as desired.

### BRIEF SUMMARY

According to some embodiments, the present invention may include an acoustic building panel comprising: a body comprising: inorganic fiber in an amount ranging from about 60.0 wt. % to about 90.0 wt. % based on the total weight of the body; and biochar in an amount ranging from about 10.0 wt. % to about 40.0 wt. % based on the total weight of the body; wherein the biochar has an average particle size ranging from about 0.1 mm to about 5 mm.

According to some embodiments, the present invention may include an acoustic building panel comprising: a body comprising: inorganic fiber; and biochar; wherein the body has a bulk density ranging from about 0.03 g/cm³ to about 0.25 g/cm³.

According to some embodiments, the present invention may include an acoustic building panel comprising: a body comprising: inorganic fiber; and biochar; wherein the body has a porosity ranging from about 80.0% to about 95.0%.

According to some embodiments, the present invention may include a method of manufacturing an acoustic building panel comprising: mixing a liquid carrier, inorganic fiber, biochar, and a binder to form a blend; shaping and drying the blend into a body having a first major surface opposite a second major surface and side surfaces extending between the first and second major surface; wherein the body is substantially free of the liquid carrier.

According to some embodiments, the present invention may include an acoustic building panel comprising: a body comprising: inorganic fiber in an amount ranging from about 60.0 wt. % to about 90.0 wt. % based on the total weight of the body; biochar ranging in an amount from about 10.0 wt. % to about 40.0 wt. % based on the total weight of the body; and a flame retardant.

According to some embodiments, the present invention may include a method of manufacturing an acoustic building panel comprising: mixing a liquid carrier, inorganic fiber, biochar, a flame retardant, and a binder to form a blend; and shaping and drying the blend into a body having a first major surface opposite a second major surface and side surfaces extending between the first and second major surface; wherein the body is substantially free of the liquid carrier.

According to some embodiments, the present invention may include a building panel comprising: a body comprising: an inorganic material in an amount ranging from about 1 wt. % to about 99 wt. % based on the total weight of the body, wherein the inorganic material comprises an alkaline earth metal compound; biochar in an amount ranging from about 10 wt. % to about 40 wt. % based on the total weight of the body; and a flame retardant in an amount ranging from about 1 wt. % to about 15 wt. % based on the total weight of the body, wherein the flame retardant comprises an active filler flame retardant.

According to some embodiments, the present invention may include a method of manufacturing an acoustic building panel comprising: mixing an inorganic material, biochar, a flame retardant, and a liquid carrier to form a blend; and shaping and hardening the blend into a body having a first major surface opposite a second major surface and side surfaces extending between the first and second major surface; wherein: the inorganic material comprises an alkaline earth metal compound; the flame retardant comprises an active filler flame retardant; the inorganic material is present in an amount ranging from about 1 wt. % to about 99 wt. % based on the total weight of the hardened body; the biochar is present in an amount ranging from about 10 wt. % to about 40 wt. % based on the total weight of the hardened body; and the flame retardant is present in an amount ranging from about 1 wt. % to about 15 wt. % based on the total weight of the hardened body.

According to some embodiments, the present invention may include a building panel comprising: a body comprising: an inorganic material in an amount ranging from about 1 wt. % to about 99 wt. % based on the total weight of the body; biochar in an amount ranging from about 1 wt. % to about 40 wt. % based on the total weight of the body; and a flame retardant in an amount ranging from about 1 wt. % to about 15 wt. % based on the total weight of the body, wherein the flame retardant comprises an active filler flame retardant.

According to some embodiments, the present invention may include a ceiling system comprising: a support structure; and at least one of the previously discussed building panels.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is top perspective view of a building panel according to some embodiments of the present invention;

FIG. 2 is a cross-sectional view of the building panel of FIG. 1, the cross-sectional view being along the II line set forth in FIG. 1;

FIG. 3 is a ceiling system comprising a building panel according to some embodiments of the present invention;

FIG. 4 is a top perspective view of a building panel according to some embodiments of the present invention; and

FIG. 5 is a cross-sectional view of the building panel of FIG. 4, the cross-sectional view being along the V line set forth in FIG. 4.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” less than about 0.1 wt. % based on the total of the referenced value.

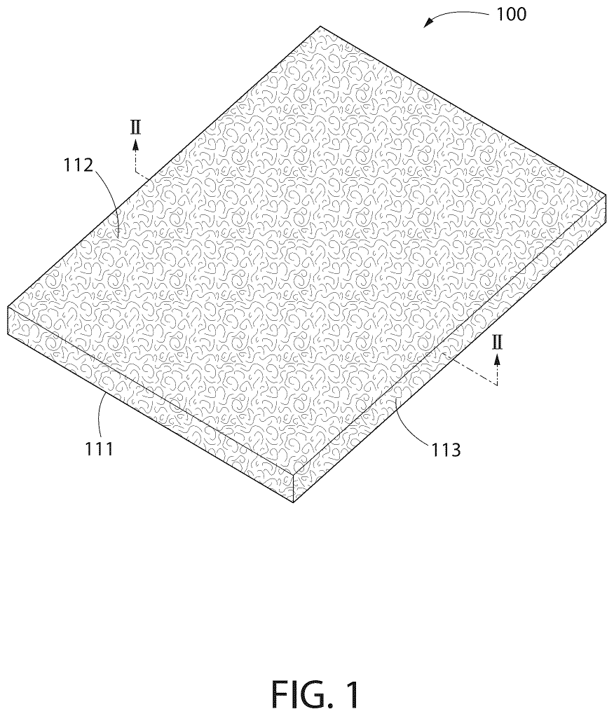

Referring to FIG. 1, in some embodiments, the building panel 100 may comprise a first major surface 111 opposite a second major surface 112. The ceiling panel 100 may further comprise a side surface 113 that extends between the first major surface 111 and the second major surface 112, thereby defining a perimeter of the ceiling panel 100.

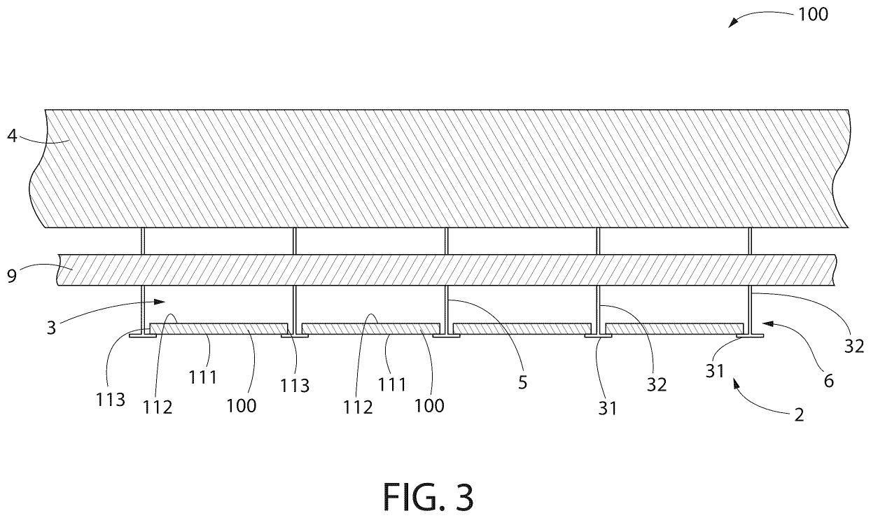

Referring to FIG. 3, in some embodiments, the present invention may further include a building system 1—also referred to as a ceiling system 1 comprising one or more of the building panels 100 installed in an interior space, whereby the interior space comprises a plenary space 3 and an active room environment 2. The plenary space 3 provides space for mechanical lines 9 within a building (e.g., HVAC, plumbing, etc.). The active space 2 provides room for the building occupants during normal intended use of the building (e.g., in an office building, the active space would be occupied by offices containing computers, lamps, etc.).

The ceiling system 1 may include a ceiling support grid 6 and at least one building panel 100 supported by the ceiling support grid 6, the building panel 100 having the first major surface 111 opposite the second major surface 112, and the second major surface 112 facing upward and the first major surface 111 facing downward.

In the installed state, the building panels 100 may be supported in the interior space by one or more parallel support struts 5. Each of the support struts 5 may comprise an inverted T-bar having a horizontal flange 31 and a vertical web 32. The ceiling system 1 may further comprise a plurality of first struts that are substantially parallel to each other and a plurality of second struts that are substantially perpendicular to the first struts (not pictured). In some embodiments, the plurality of second struts intersects the plurality of first struts to create an intersecting ceiling support grid 6. The plenary space 3 exists above the ceiling support grid and the active room environment 2 exists below the ceiling support grid 6. In the installed state, the first major surface 111 of the building panel 100 faces the active room environment 2 and the second major surface 112 of the building panel 100 faces the plenary space 3.

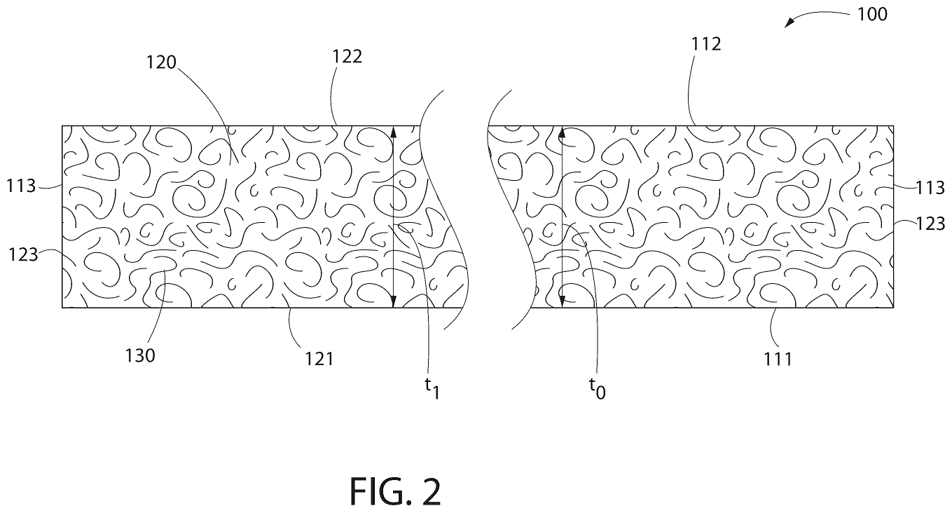

Referring now to FIGS. 1 and 2, in some embodiments, the building panel 100 of the present invention may have a panel thickness to as measured from the first major surface 111 to the second major surface 112. The panel thickness to may range from about 12 mm to about 40 mm—including all values and sub-ranges there-between. The building panel 100 may have a length ranging from about 30 cm to about 310 cm—including all values and sub-ranges there-between. The building panel 100 may have a width ranging from about 10 cm to about 125 cm—including all values and sub-ranges there-between.

In some embodiments, the building panel 100 may comprise a body 120 having an upper surface 122 opposite a lower surface 121 and a body side surface 123 that extends between the upper surface 122 and the lower surface 121, thereby defining a perimeter of the body 120. The body 120 may have a body thickness t1 that extends from the upper surface 122 to the lower surface 121. The body thickness t1 may range from about 12 mm to about 40 mm—including all values and sub-ranges there-between.

The first major surface 111 of the building panel 100 may comprise the lower surface 121 of the body 120. The second major surface 112 of the building panel 100 may comprise the upper surface 122 of the body 120. When the first major surface 111 of the building panel 100 comprises the lower surface 121 of the body 120 and the second major surface 112 of the building panel 100 comprises the upper surface 122 of the body 120, the panel thickness t0 is substantially equal to the body thickness t1.

As discussed in greater detail herein, in some embodiments, the body 120 may be porous, thereby allowing airflow through the body 120 between the upper surface 122 and the lower surface 121.

In some embodiments, the body 120 may be comprised of fibers 130. The fibers 130 may comprise a fibrous component. The fibrous component may comprise organic fiber, inorganic fiber, and combinations thereof. The body may further comprise biochar. In some embodiments, the body 120 may further comprise a filler and/or additive. The body 120 may further comprise a binder.

The first fibrous component of the fibers 130 may be organic fibers, inorganic fibers, or a blend thereof. Non-limiting examples of inorganic fibers include mineral wool (also referred to as slag wool), rock wool, stone wool, glass fibers, and polymer fibers. Non-limiting examples of polymer fibers include polyester fiber, polyethylene fiber, aramid fiber (e.g., aromatic polyamide fiber), and polypropylene fiber. Non-limiting examples of organic fiber include macroscopic cellulosic fibers (e.g. paper fiber—such as newspaper, hemp fiber, jute fiber, flax fiber, wood fiber, or other natural fibers), protein fibers (e.g., sheep wool), and combinations thereof. Depending on the specific type of material, the first fibrous component may either be hydrophilic (e.g., macroscopic cellulosic fibers) or hydrophobic (e.g. fiberglass, mineral wool, rock wool, stone wool).

The fibrous component may be present in an amount ranging from about 25 wt. % to about 95 wt. % based on the total dry weight of the body 120—including all values and sub-ranges there-between. In some embodiments, the fibrous component may be present in an amount ranging from about 55 wt. % to about 95 wt. % based on the total dry weight of the body 120—including all values and sub-ranges there-between. In some embodiments, the fibrous component may be present in an amount ranging from about 60 wt. % to about 90 wt. % based on the total dry weight of the body 120—including all values and sub-ranges there-between. In some embodiments, the fibrous component may be present in an amount ranging from about 63 wt. % to about 75 wt. % based on the total dry weight of the body 120—including all values and sub-ranges there-between.

The phrase “dry-weight” refers to the weight of a referenced component without the weight of any carrier. Thus, when calculating the weight percentages of components in the dry-state, the calculation should be based solely on the solid components (e.g., binder, filler, biochar, fibers, additive, etc.) and should exclude any amount of residual carrier (e.g., water, VOC solvent) that may still be present from a wet-state, which will be discussed further herein. According to the present invention, the phrase “dry-state” may also be used to indicate a component that is substantially free of a carrier, as compared to the term “wet-state,” which refers to that component still containing various amounts of carrier—as discussed further herein.

In some embodiments, the fibrous component may be inorganic fiber, such as mineral wool, whereby the inorganic fiber is present in an amount ranging from about 55 wt. % to about 90 wt. %—including all weight percentages and sub-ranges there-between—based on the total weight of the body 120. In some embodiments, the fibrous component may be inorganic fiber, such as mineral wool, whereby the inorganic fiber is present in an amount ranging from about 60 wt. % to about 90 wt. %—including all weight percentages and sub-ranges there-between—based on the total weight of the body 120. In some embodiments, the fibrous component may be inorganic fiber, such as mineral wool, whereby the inorganic fiber is present in an amount ranging from about 60 wt. % to about 75 wt. %—including all weight percentages and sub-ranges there-between—based on the total weight of the body 120. In some embodiments, the fibrous component may be substantially free of inorganic fiber. In some embodiments, the fibrous component may comprise inorganic fiber in an amount ranging from 0 wt. % to about 90 wt. % or from 0 wt. % to about 85 wt. %—including all weight percentages and sub-ranges there-between—based on the total weight of the body 120.

In some embodiments, the fibrous component may further comprise macroscopic cellulosic fiber, such as recycled newspaper. In some embodiments, the cellulosic fiber may be present in an amount ranging from about 0.1 wt. % to about 5.0 wt. %—including all weight percentages and sub-ranges there-between—based on the total weight of the body 120. In some embodiments, the fibrous component may further comprise cellulosic fiber in an amount ranging from about 0.5 wt. % to about 3.0 wt. %—based on the total weight of the body 120.

In some embodiments, the body 120 may further comprise biochar. The term biochar may be interchangeable with the term “biocoal” and refers to pyrolyzed biomass. Biochar production removes carbon dioxide directly from the atmosphere through uptake by plants—thereby allowing an actual reduction of atmospheric carbon dioxide levels. With this in mind, the creation of acoustic panels comprising a body formed, in part, of biochar helps reduce carbon footprint and thereby alleviate global warming potential as biochar is a carbon negative material—i.e., production eliminates CO2 from the atmosphere.

In some embodiments, the biochar may have a density ranging from about 3 pounds per cubic foot (pcf) to about 18 pcf. For example, in some embodiments, the biochar may have a density ranging from about 3 pcf to about 18 pcf, from about 5 pcf to about 18 pcf, from about 7 pcf to about 18 pcf, from about 9 pcf to about 18 pcf, from about 11 pcf to about 18 pcf, from about 13 pcf to about 18 pcf, from about 15 pcf to about 18 pcf, from about 17 pcf to about 18 pcf, from about 3 pcf to about 17 pcf, from about 5 pcf to about 17 pcf, from about 7 pcf to about 17 pcf, from about 9 pcf to about 17 pcf, from about 11 pcf to about 17 pcf, from about 13 pcf to about 17 pcf, from about 15 pcf to about 17 pcf, from about 3 pcf to about 15 pcf, from about 5 pcf to about 15 pcf, from about 7 pcf to about 15 pcf, from about 9 pcf to about 15 pcf, from about 11 pcf to about 15 pcf, from about 13 pcf to about 15 pcf, from about 3 pcf to about 13 pcf, from about 5 pcf to about 13 pcf, from about 7 pcf to about 13 pcf, from about 9 pcf to about 13 pcf, from about 11 pcf to about 13 pcf, from about 3 pcf to about 11 pcf, from about 5 pcf to about 11 pcf, from about 7 pcf to about 11 pcf, from about 9 pcf to about 11 pcf, from about 3 pcf to about 9 pcf, from about 5 pcf to about 9 pcf, from about 7 pcf to about 9 pcf, from about 3 pcf to about 7 pcf, from about 5 pcf to about 7 pcf, from about 3 pcf to about 5 pcf, or any other suitable values or sub-ranges there-between.

The biochar may be machined to a specific particle size distribution. The biochar may have an average particle size ranging from about 0.1 mm to about 5 mm—including all sizes and sub-ranges there-between. For example, in some embodiments, the biochar may have an average particle size ranging from about 0.1 mm to about 5 mm, from about 0.5 mm to about 5 mm, from about 1 mm to about 5 mm, from about 1.5 mm to about 5 mm, from about 2 mm to about 5 mm, from about 2.5 mm to about 5 mm, from about 3 mm to about 5 mm, from about 3.5 mm to about 5 mm, from about 4 mm to about 5 mm, from about 4.5 mm to about 5 mm, from about 0.1 mm to about 4.5 mm, from about 0.5 mm to about 4.5 mm, from about 1 mm to about 4.5 mm, from about 1.5 mm to about 4.5 mm, from about 2 mm to about 4.5 mm, from about 2.5 mm to about 4.5 mm, from about 3 mm to about 4.5 mm, from about 3.5 mm to about 4.5 mm, from about 4 mm to about 4.5 mm, from about 0.1 mm to about 4 mm, from about 0.5 mm to about 4 mm, from about 1 mm to about 4 mm, from about 1.5 mm to about 4 mm, from about 2 mm to about 4 mm, from about 2.5 mm to about 4 mm, from about 3 mm to about 4 mm, from about 3.5 mm to about 4 mm, from about 0.1 mm to about 3.5 mm, from about 0.5 mm to about 3.5 mm, from about 1 mm to about 3.5 mm, from about 1.5 mm to about 3.5 mm, from about 2 mm to about 3.5 mm, from about 2.5 mm to about 3.5 mm, from about 3 mm to about 3.5 mm, from about 0.1 mm to about 3 mm, from about 0.5 mm to about 3 mm, from about 1 mm to about 3 mm, from about 1.5 mm to about 3 mm, from about 2 mm to about 3 mm, from about 2.5 mm to about 3 mm, from about 0.1 mm to about 2.5 mm, from about 0.5 mm to about 2.5 mm, from about 1 mm to about 2.5 mm, from about 1.5 mm to about 2.5 mm, from about 2 mm to about 2.5 mm, from about 0.1 mm to about 2 mm, from about 0.5 mm to about 2 mm, from about 1 mm to about 2 mm, from about 1.5 mm to about 2 mm, from about 0.1 mm to about 1.5 mm, from about 0.5 mm to about 1.5 mm, from about 1 mm to about 1.5 mm, from about 0.1 mm to about 1 mm, from about 0.5 mm to about 1 mm, from about 0.1 mm to about 0.5 mm, or any other suitable values or sub-ranges there-between. In some embodiments, the biochar may have an average particle size ranging from about 0.2 mm to about 5 mm—including all sizes and sub-ranges there-between. In some embodiments, the biochar may have an average particle size ranging from about 0.5 mm to about 5 mm—including all sizes and sub-ranges there-between. In some embodiments, the biochar may have an average particle size ranging from about 1.5 mm to about 4 mm—including all sizes and sub-ranges there-between. In some embodiments, the biochar may have an average particle size ranging from about 2.5 mm to about 3.5 mm—including all sizes and sub-ranges there-between. In some embodiments, the biochar may have an average particle size ranging from about 2 mm to about 3 mm—including all sizes and sub-ranges there-between. In some embodiments, the biochar may have an average particle size that is less than 2 mm.

In some embodiments, the biochar may comprise a first biochar component and a second biochar component. The first biochar component may have a first particle size and the second biochar may have a second particle size, whereby the first particle size and the second particle size are not equal. In some embodiments, the first particle size may range from about 2.5 mm to about 5 mm—including all sizes and sub-ranges there-between. In some embodiments, the second particle size may range from about 0.1 mm to about 2 mm—including all sizes and sub-ranges there-between. In some embodiments, the second particle size may be less than 2.0 mm.

In some embodiments, the biochar may be present in an amount ranging from about 10 wt. % to about 40 wt. % based on the total dry weight of the body 120—including all values and sub-ranges there-between. For example, in some embodiments, the biochar may be present in an amount ranging from about 10 wt. % to about 40 wt. %, from about 13 wt. % to about 40 wt. %, from about 17 wt. % to about 40 wt. %, from about 20 wt. % to about 40 wt. %, from about 23 wt. % to about 40 wt. %, from about 27 wt. % to about 40 wt. %, from about 30 wt. % to about 40 wt. %, from about 33 wt. % to about 40 wt. %, from about 37 wt. % to about 40 wt. %, from about 10 wt. % to about 37 wt. %, from about 13 wt. % to about 37 wt. %, from about 17 wt. % to about 37 wt. %, from about 20 wt. % to about 37 wt. %, from about 23 wt. % to about 37 wt. %, from about 27 wt. % to about 37 wt. %, from about 30 wt. % to about 37 wt. %, from about 33 wt. % to about 37 wt. %, from about 10 wt. % to about 33 wt. %, from about 13 wt. % to about 33 wt. %, from about 17 wt. % to about 33 wt. %, from about 20 wt. % to about 33 wt. %, from about 23 wt. % to about 33 wt. %, from about 27 wt. % to about 33 wt. %, from about 30 wt. % to about 33 wt. %, from about 10 wt. % to about 30 wt. %, from about 13 wt. % to about 30 wt. %, from about 17 wt. % to about 30 wt. %, from about 20 wt. % to about 30 wt. %, from about 23 wt. % to about 30 wt. %, from about 27 wt. % to about 30 wt. %, from about 10 wt. % to about 27 wt. %, from about 13 wt. % to about 27 wt. %, from about 17 wt. % to about 27 wt. %, from about 20 wt. % to about 27 wt. %, from about 23 wt. % to about 27 wt. %, from about 10 wt. % to about 23 wt. %, from about 13 wt. % to about 23 wt. %, from about 17 wt. % to about 23 wt. %, from about 20 wt. % to about 23 wt. %, from about 10 wt. % to about 20 wt. %, from about 13 wt. % to about 20 wt. %, from about 17 wt. % to about 20 wt. %, from about 10 wt. % to about 17 wt. %, from about 13 wt. % to about 17 wt. %, from about 10 wt. % to about 13 wt. %, or any other suitable values or sub-ranges there-between, based on the total dry weight of the body 120. In some embodiments, the biochar may be present in an amount ranging from about 10 wt. % to about 30 wt. % based on the total dry weight of the body 120—including all values and sub-ranges there-between. In some embodiments, the biochar may be present in an amount ranging from about 15 wt. % to about 25 wt. % based on the total dry weight of the body 120—including all values and sub-ranges there-between. In some embodiment, the biochar may be present in an amount ranging from about 18 wt. % to about 23 wt. % based on the total dry weight of the body 120—including all values and sub-ranges there-between. In some embodiment, the biochar may be present in an amount ranging from about 19 wt. % to about 20 wt. % based on the total dry weight of the body 120—including all values and sub-ranges there-between.

The fibers 130 of the present invention may comprise the inorganic fiber and the organic fiber in a weight ratio ranging from about 1:5 to about 27:1—including all ratios and sub-ranges there-between. In some embodiments, the fibers 130 of the present invention may comprise the inorganic fiber and the organic fiber in a weight ratio ranging from about 1:1 to about 27:1—including all ratios and sub-ranges there-between. In some embodiments, the fibers 130 of the present invention may comprise the inorganic fiber and the organic fiber in a weight ratio ranging from about 15:1 to about 27:1—including all ratios and sub-ranges there-between. In some embodiments, the fibers 130 of the present invention may comprise the inorganic fiber component and the organic fiber in a weight ratio ranging from about 18:1 to about 25:1—including all ratios and sub-ranges there-between. In some embodiments, the inorganic fiber and the organic fiber may be present in a weight ratio ranging from about 20:1 to about 23:1—including all ratios and sub-ranges there-between.

The fibers 130 and the biochar may be present in a weight ratio ranging from about 1.5:1 to about 6.0:1—including all ratios and sub-ranges there-between. In some embodiments, the fibers 130 and the biochar may be present in a weight ratio ranging from about 2.0:1 to about 5.5:1—including all ratios and sub-ranges there-between. In some embodiments, the fibers 130 and the biochar may be present in a weight ratio ranging from about 2.5:1 to about 5.5:1—including all ratios and sub-ranges there-between. In some embodiments, the fibers 130 and the biochar may be present in a weight ratio ranging from about 3:1 to about 5:1—including all ratios and sub-ranges there-between. In some embodiments, the fibers 130 and the biochar may be present in a weight ratio ranging from about 3:1 to about 4:1—including all ratios and sub-ranges there-between.

The inorganic fibers and the biochar may be present in a weight ratio ranging from about 2:1 to about 5.5:1—including all ratios and sub-ranges there-between. In some embodiments, the inorganic fibers and the biochar may be present in a weight ratio ranging from about 2.5:1 to about 5:1—including all ratios and sub-ranges there-between. In some embodiments, the inorganic fibers and the biochar may be present in a weight ratio ranging from about 3:1 to about 5:1—including all ratios and sub-ranges there-between. In some embodiments, the fibers 130 and the biochar may be present in a weight ratio ranging from about 3:1 to about 4:1—including all ratios and sub-ranges there-between. In some embodiments, the fibers 130 and the biochar may be present in a weight ratio ranging from about 3.1:1 to about 3.9:1—including all ratios and sub-ranges there-between.

The organic fibers and the biochar may be present in a weight ratio ranging from about 0.1:1 to about 0.3:1—including all ratios and sub-ranges there-between. In some embodiments, the fibers 130 and the biochar may be present in a weight ratio ranging from about 0.1:1 to about 0.2:1—including all ratios and sub-ranges there-between. In some embodiments, the fibers 130 and the biochar may be present in a weight ratio of about 0.15:1.

The body 120 may further comprise a binder. Non-limiting examples of binder may include a starch-based polymer, polyvinyl alcohol (PVOH), a latex, polysaccharide polymers, cellulosic polymers, protein solution polymers, an acrylic polymer, polymaleic anhydride, epoxy resins, or a combination of two or more thereof.

The binder may be present in an amount ranging from about 1 wt. % to about 20 wt. % based on the total dry weight of the body 120—including all values and sub-ranges there-between. In a preferred embodiment, the binder may be present in an amount ranging from about 5 wt. % to about 15 wt. % based on the total dry weight of the body 120—including all values and sub-ranges there-between. In a non-limiting example, the binder may comprise a starch-based polymer, which is present in an amount ranging from about 6 wt. % to about 12 wt. %—including all weight percentages and sub-range there-between—based on the total dry weight of the body 120.

The body 120 may further comprise a filler. Non-limiting examples of filler may include powders of calcium carbonate, limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, or zinc sulfate.

The filler may be present in an amount ranging from about 1.0 wt. % to about 30.0 wt. % based on the total dry weight of the body 120—including all values and sub-ranges there-between. In some embodiments, the filler may be present in an amount ranging from about 1.0 wt. % to about 20.0 wt. % based on the total dry weight of the body 120—including all values and sub-ranges there-between. In some embodiments, the filler may be present in an amount ranging from about 5.0 wt. % to about 18.0 wt. % based on the total dry weight of the body 120—including all values and sub-ranges there-between.

In a preferred embodiment, the filler may be perlite, which is present in an amount ranging from about 5 wt. % to about 17 wt. %—based on the total weight of the body 120—including all amounts and sub-ranges there-between.

In some embodiments, the body 120 may further comprise filler that includes calcium carbonate. The calcium carbonate may be present in the body 120 in an amount ranging from about 0.25 wt. % to 13 wt. %—based on the total weight of the body 120—including all amounts and sub-ranges there-between. In some embodiments, the calcium carbonate may be present in an amount ranging from about 0.5 wt. % to about 8 wt. % based on the total dry weight of the body 120—including all values and sub-ranges there-between. In some embodiments, the calcium carbonate may be present in an amount ranging from about 1.0 wt. % to about 3.0 wt. % based on the total dry weight of the body 120—including all values and sub-ranges there-between. In some embodiments, the body 120 may be substantially free of filler.

In some embodiments, the body 120 may include one or more additives. Non-limiting examples of additive include defoamers, wetting agents, biocides, dispersing agents, flame retardants, and the like. The additive may be present in an amount ranging from about 0.01 wt. % to about 30 wt. % based on the total dry weight of the body 120—including all values and sub-ranges there-between.

In some embodiments, the body 120 may include a flame retardant. In some embodiments, the flame retardant may be present in the body 120 in an amount ranging from about 1 wt. % to about 15 wt. % based on the total dry weight of the body 120—including all values and sub-ranges therebetween. For example, in some embodiments, the flame retardant may be present in the body 120 in an amount ranging from about 1 wt. % to about 15 wt. %, from about 3 wt. % to about 15 wt. %, from about 5 wt. % to about 15 wt. %, from about 7 wt. % to about 15 wt. %, from about 9 wt. % to about 15 wt. %, from about 11 wt. % to about 15 wt. %, from about 13 wt. % to about 15 wt. %, from about 1 wt. % to about 13 wt. %, from about 3 wt. % to about 13 wt. %, from about 5 wt. % to about 13 wt. %, from about 7 wt. % to about 13 wt. %, from about 9 wt. % to about 13 wt. %, from about 11 wt. % to about 13 wt. %, from about 1 wt. % to about 11 wt. %, from about 3 wt. % to about 11 wt. %, from about 5 wt. % to about 11 wt. %, from about 7 wt. % to about 11 wt. %, from about 9 wt. % to about 11 wt. %, from about 1 wt. % to about 9 wt. %, from about 3 wt. % to about 9 wt. %, from about 5 wt. % to about 9 wt. %, from about 7 wt. % to about 9 wt. %, from about 1 wt. % to about 7 wt. %, from about 3 wt. % to about 7 wt. %, from about 5 wt. % to about 7 wt. %, from about 1 wt. % to about 5 wt. %, from about 3 wt. % to about 5 wt. %, or from about 1 wt. % to about 3 wt. %, or any other suitable values or sub-ranges there-between, based on the total dry weight of the body 120.

In some embodiments, the flame retardant may have an average particle size ranging from about 1 μm to about 100 μm—including all values and sub-ranges there-between. For example, in some embodiments, the flame retardant may have an average particle size ranging from about 1 μm to about 100 μm, from about 25 μm to about 100 μm, from about 50 μm to about 100 μm, from about 75 μm to about 100 μm, from about 1 μm to about 75 μm, from about 25 μm to about 75 μm, from about 50 μm to about 75 μm, from about 1 μm to about 50 μm, from about 25 μm to about 50 μm, from about 1 μm to about 25 μm, or any other suitable values or sub-ranges there-between.

In some embodiments, the flame retardant may include an active filler flame retardants. In some embodiments, the term active filler flame retardant may refer to a flame retardant that may decompose at an elevated temperature ranging from about 200° C. to about 325° C. Depending on the particular active filler flame retardant, in some embodiments, the active filler flame retardant may decompose at an elevated temperature ranging from about 200° C. to about 325° C., from about 225° C. to about 325° C., from about 250° C. to about 325° C., from about 275° C. to about 325° C., from about 300° C. to about 325° C., 200° C. to about 300° C., from about 225° C. to about 300° C., from about 250° C. to about 300° C., from about 275° C. to about 300° C., 200° C. to about 275° C., from about 225° C. to about 275° C., from about 250° C. to about 275° C., 200° C. to about 250° C., from about 225° C. to about 250° C., 200° C. to about 225° C., or any other suitable values or sub-ranges there-between. In some embodiments, the active filler flame retardant may decompose endothermically and absorb heat from the surroundings. Thus, in some embodiments, the active filler flame retardant may function as a heat sink. In some embodiments, upon decomposition, the flame retardant may emit water (H2O), such as water vapor.

Non-limiting example of the flame retardant or the active filler flame retardant may include colemanite, aluminum hydroxide, magnesium hydroxide, boehmite, hydrous or calcined clay, calcium carbonate, talc, feldspar, or a combination of two or more thereof.

As discussed above, the phrase “dry-weight” used herein refers to the weight of a referenced component without the weight of any carrier. It should be noted that the term “carrier” refers to a liquid carrier not as part of a hydrous component, such as some of the hydrous flame retardants discussed above. Such liquid carrier may be capable of evaporation from a mixture or blend during a drying or hardening process at a temperature ranging from about 60° C. to about 200° C. as discussed further herein. However, the hydrous compound may not lose its hydration during such drying or hardening process. Thus, when calculating the weight percentages of the hydrous component, such as the weight percentage of the flame retardant in the dry-state, the calculation is based on the weight of the hydrous component (including hydration that may not evaporate in the drying or hardening process) and the weight of the body 120 without any liquid carrier that is capable of evaporation from the body 120 during the drying or hardening process.

In some embodiments, the body 120 may further comprise a flocculant. Non-limiting examples of flocculants include ionic flocculants, such as cationic polyacrylamide. The flocculant may be present in an amount ranging from about 0.01 wt. % to about 1.0 wt. % based on the total dry weight of the body 120—including all values and sub-ranges there-between.

The body 120 may be porous, thereby allowing airflow through the body 120 between the upper surface 122 and the lower surface 121—as discussed further herein. The porosity of the body 120 may allow for airflow through the body 120 under atmospheric conditions such that the building panel 100 may function as an acoustic ceiling panel, which requires properties related to noise reduction and sound attenuation properties—as discussed further herein.

Specifically, in some embodiments, the body 120 of the present invention may have a porosity ranging from about 60% to about 98%—including all values and sub-ranges there between. In some embodiments, the body 120 may have a porosity ranging from about 75% to 95%—including all values and sub-ranges there between. In some embodiments, the body 120 may have a porosity ranging from about 80% to 95%—including all values and sub-ranges there between. In some embodiments, the body 120 may have a porosity ranging from about 85% to 95%—including all values and sub-ranges there between. In some embodiments, the body 120 may have a porosity ranging from about 90% to 95%—including all values and sub-ranges there between.

According to the present invention, porosity refers to the following:

% Porosity=[V_{Total}−(V_{Binder}+V_{Fiber}+V_{Biochar}+V_{Filler/Additive})]/V_{Total}

Where V_{Total} refers to the total volume of the body 120 defined by the upper surface 122, the lower surface 121, and the body side surfaces 123. V_{Binder} refers to the total volume occupied by the binder in the body 120. V_{Fiber} refers to the total volume occupied by the fibers 130 in the body 120. V_{Biochar} refers to the total volume occupied by the biochar in the body 120. V_{Filler/Additive} refers to the total volume occupied by the filler and additive in the body 120. Thus, the % porosity represents the amount of free volume within the body 120.

The building panel 100 of the present invention comprising the porous body 120 may exhibit sufficient airflow for the building panel 100 to have the ability to reduce the amount of reflected sound in a room. The reduction in amount of reflected sound in a room is expressed by a Noise Reduction Coefficient (NRC) rating as described in American Society for Testing and Materials (ASTM) test method C423. This rating is the average of sound absorption coefficients at four ⅓ octave bands (250, 500, 1000, and 2000 Hz), where, for example, a system having an NRC of 0.90 has about 90% of the absorbing ability of an ideal absorber. A higher NRC value indicates that the material provides better sound absorption and reduced sound reflection.

The building panel 100 of the present invention exhibits an NRC of at least about 0.5. In a preferred embodiment, the building panel 100 of the present invention may have an NRC ranging from about 0.60 to about 0.99—including all value and sub-ranges there-between.

The body 100 may also exhibit an airflow resistance as measured between the upper surface 122 and the lower surface 121 that ranges from about 200 MKS Rayls to about 40,000 MKS Rayls—including all airflow resistances and sub-ranges there-between—MKS Rayls being measured in units of Pa*s/m.

The body 120 in the dry-state may have a bulk density ranging from about 0.03 g/cm³ to about 0.25 g/cm³—including all integers and sub-ranges there between. The term “bulk density” refers to the density as measured relative to the total volume V_{Total} of the body 120. Therefore, bulk density is a density measurement of that includes the total volume V_{Total}, which includes both the volume occupied by the components that make up the skeleton of the body 120 (i.e., (V_{Binder}+V_{Fiber}+V_{Biochar}+V_{Filler/Additive}) as well as the voids within the body 120 due to the porous nature of the body 120.

In some embodiments, the body 120 in the dry-state may have a bulk density ranging from about 0.13 g/cm³ to about 0.25 g/cm³—including all integers and sub-ranges there between. In some embodiments, the body 120 in the dry-state may have a bulk density ranging from about 0.18 g/cm³ to about 0.21 g/cm³—including all integers and sub-ranges there between. In some embodiments, the body 120 in the dry-state may have a bulk density ranging from about 0.03 g/cm³ to about 0.05 g/cm³—including all integers and sub-ranges there between.

In some embodiments, the body 120 in the dry-state may have a bulk density ranging from about 0.03 g/cm³ to about 0.25 g/cm³, from about 0.05 g/cm³ to about 0.25 g/cm³, from about 0.07 g/cm³ to about 0.25 g/cm³, from about 0.09 g/cm³ to about 0.25 g/cm³, from about 0.11 g/cm³ to about 0.25 g/cm³, from about 0.13 g/cm³ to about 0.25 g/cm³, from about 0.15 g/cm³ to about 0.25 g/cm³, from about 0.17 g/cm³ to about 0.25 g/cm³, from about 0.19 g/cm³ to about 0.25 g/cm³, from about 0.21 g/cm³ to about 0.25 g/cm³, from about 0.23 g/cm³ to about 0.25 g/cm³, from about 0.03 g/cm³ to about 0.23 g/cm³, from about 0.05 g/cm³ to about 0.23 g/cm³, from about 0.07 g/cm³ to about 0.23 g/cm³, from about 0.09 g/cm³ to about 0.23 g/cm³, from about 0.11 g/cm³ to about 0.23 g/cm³, from about 0.13 g/cm³ to about 0.23 g/cm³, from about 0.15 g/cm³ to about 0.23 g/cm³, from about 0.17 g/cm³ to about 0.23 g/cm³, from about 0.19 g/cm³ to about 0.23 g/cm³, from about 0.21 g/cm³ to about 0.23 g/cm³, from about 0.03 g/cm³ to about 0.21 g/cm³, from about 0.05 g/cm³ to about 0.21 g/cm³, from about 0.07 g/cm³ to about 0.21 g/cm³, from about 0.09 g/cm³ to about 0.21 g/cm³, from about 0.11 g/cm³ to about 0.21 g/cm³, from about 0.13 g/cm³ to about 0.21 g/cm³, from about 0.15 g/cm³ to about 0.21 g/cm³, from about 0.17 g/cm³ to about 0.21 g/cm³, from about 0.19 g/cm³ to about 0.21 g/cm³, from about 0.03 g/cm³ to about 0.19 g/cm³, from about 0.05 g/cm³ to about 0.19 g/cm³, from about 0.07 g/cm³ to about 0.19 g/cm³, from about 0.09 g/cm³ to about 0.19 g/cm³, from about 0.11 g/cm³ to about 0.19 g/cm³, from about 0.13 g/cm³ to about 0.19 g/cm³, from about 0.15 g/cm³ to about 0.19 g/cm³, from about 0.17 g/cm³ to about 0.19 g/cm³, from about 0.03 g/cm³ to about 0.17 g/cm³, from about 0.05 g/cm³ to about 0.17 g/cm³, from about 0.07 g/cm³ to about 0.17 g/cm³, from about 0.09 g/cm³ to about 0.17 g/cm³, from about 0.11 g/cm³ to about 0.17 g/cm³, from about 0.13 g/cm³ to about 0.17 g/cm³, from about 0.15 g/cm³ to about 0.17 g/cm³, from about 0.03 g/cm³ to about 0.15 g/cm³, from about 0.05 g/cm³ to about 0.15 g/cm³, from about 0.07 g/cm³ to about 0.15 g/cm³, from about 0.09 g/cm³ to about 0.15 g/cm³, from about 0.11 g/cm³ to about 0.15 g/cm³, from about 0.13 g/cm³ to about 0.15 g/cm³, from about 0.03 g/cm³ to about 0.13 g/cm³, from about 0.05 g/cm³ to about 0.13 g/cm³, from about 0.07 g/cm³ to about 0.13 g/cm³, from about 0.09 g/cm³ to about 0.13 g/cm³, from about 0.11 g/cm³ to about 0.13 g/cm³, from about 0.03 g/cm³ to about 0.11 g/cm³, from about 0.05 g/cm³ to about 0.11 g/cm³, from about 0.07 g/cm³ to about 0.11 g/cm³, from about 0.09 g/cm³ to about 0.11 g/cm³, from about 0.03 g/cm³ to about 0.09 g/cm³, from about 0.05 g/cm³ to about 0.09 g/cm³, from about 0.07 g/cm³ to about 0.09 g/cm³, from about 0.03 g/cm³ to about 0.07 g/cm³, from about 0.05 g/cm³ to about 0.07 g/cm³, from about 0.03 g/cm³ to about 0.05 g/cm³, or any other suitable values or sub-ranges there-between.

The body 120 in the dry-state may have a skeletal density ranging from about 0.35 g/cm³ to about 2.7 g/cm³—including all integers and sub-ranges there between. The term “skeletal density” refers to the density as measured relative to only the volume occupied by the components that make up the skeleton of the body 120 (i.e., (V_{Binder}+V_{Fiber}+V_{Biochar}+V_{Filler/Additive}) without accounting for the volume occupied by the voids within the body 120 due to the porous nature of the body 120. In some embodiments, the body may have a skeletal density ranging from about 0.73 g/cm³ to about 2.7 g/cm³—including all values and sub-ranges there-between.

In some embodiments, the body 120 in the dry-state may have a skeletal density ranging from about 0.35 g/cm³ to about 2.7 g/cm³, from about 0.7 g/cm³ to about 2.7 g/cm³, from about 1 g/cm³ to about 2.7 g/cm³, from about 1.35 g/cm³ to about 2.7 g/cm³, from about 1.7 g/cm³ to about 2.7 g/cm³, from about 2 g/cm³ to about 2.7 g/cm³, from about 2.35 g/cm³ to about 2.7 g/cm³, from about 0.35 g/cm³ to about 2.35 g/cm³, from about 0.7 g/cm³ to about 2.35 g/cm³, from about 1 g/cm³ to about 2.35 g/cm³, from about 1.35 g/cm³ to about 2.35 g/cm³, from about 1.7 g/cm³ to about 2.35 g/cm³, from about 2 g/cm³ to about 2.35 g/cm³, from about 0.35 g/cm³ to about 2 g/cm³, from about 0.7 g/cm³ to about 2 g/cm³, from about 1 g/cm³ to about 2 g/cm³, from about 1.35 g/cm³ to about 2 g/cm³, from about 1.7 g/cm³ to about 2 g/cm³, from about 0.35 g/cm³ to about 1.7 g/cm³, from about 0.7 g/cm³ to about 1.7 g/cm³, from about 1 g/cm³ to about 1.7 g/cm³, from about 1.35 g/cm³ to about 1.7 g/cm³, from about 0.35 g/cm³ to about 1.35 g/cm³, from about 0.7 g/cm³ to about 1.35 g/cm³, from about 1 g/cm³ to about 1.35 g/cm³, from about 0.35 g/cm³ to about 1 g/cm³, from about 0.7 g/cm³ to about 1 g/cm³, from about 0.35 g/cm³ to about 0.7 g/cm³, or any other suitable values or sub-ranges there-between.

According to the present invention, it has been surprisingly discovered that the addition of biochar results in a building panel having a reduction in global warming potential (“GWP”) without sacrifice to density, porosity, and airflow resistivity necessary for the building panel to function as an acoustic building panel in a building system 1.

Although not pictured, the building panel 100 of the present invention may further comprise a scrim attached to at least one of the lower surface 121 or the upper surface 122 of the body 120. The scrim may be a non-woven scrim formed of glass fibers. In such embodiments, the first major surface 111 of the building panel 100 may comprise the scrim.

In some embodiments, the body 120 may be formed according to a standard wet-laid process that uses an aqueous medium or liquid carrier (e.g., water) to transport and form the body components into the desired structure. The basic process involves first blending the various body ingredients (e.g., fibers, binder, biochar, filler, additive, etc.) into an aqueous slurry—(i.e., the wet-state), transporting the slurry to a forming station, and distributing the slurry over a moving, porous wire web into a uniform mat having the desired size and thickness. The liquid carrier is removed, and the mat is dried (i.e., the dry-state). The dried mat may be finished into the body by slitting, punching, coating and/or laminating a surface finish to the tile. The body 120 in the wet-state may be heated at an elevated temperature ranging from about 60° C. to about 200° C. —including all values and sub-ranges there-between—to dry the body 120 from the wet-state to the dry-state.

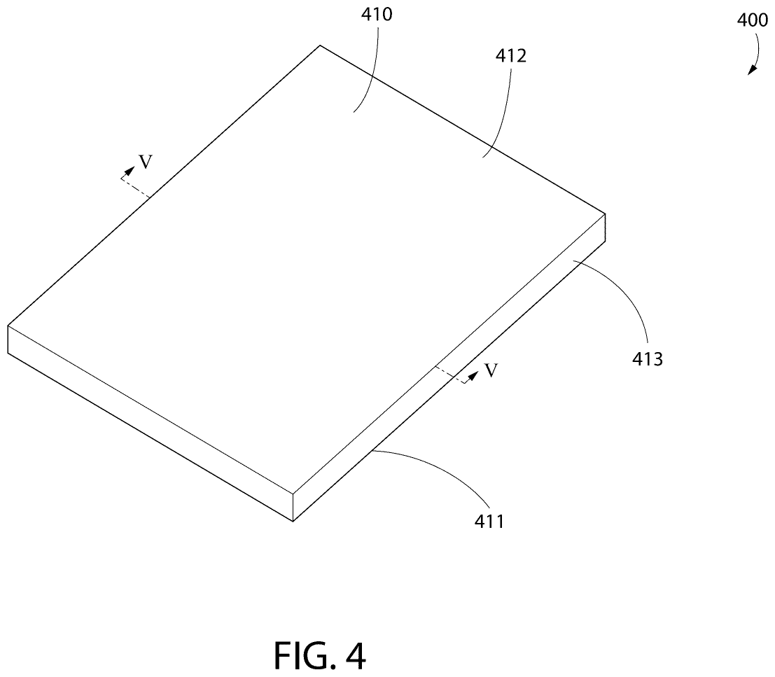

Referring now to FIG. 4, a building panel 400 is illustrated in accordance with another embodiment of the present invention. Similar to the building panel 100, the building panel 400 may be used for establishing or incorporation into the building system 1. The building panel may include an inorganic material, including but not limited to inorganic particles, biochar, a flame retardant, fibers, and so on.

In some embodiments, the building panel 400 may include a first major surface 411 opposite a second major surface 412. The building panel 400 may further include a side surface 413 that extends between the first major surface 411 and the second major surface 412, thereby defining a perimeter of the building panel 400.

In some embodiments, the building panel 400 may have a panel thickness as measured from the first major surface 411 to the second major surface 412. The panel thickness may range from about 0.4″ to about 1″—including all values and sub-ranges there-between. The building panel 400 may have a length ranging from about 12″ to about 72″—including all values and sub-ranges there-between. The building panel 400 may have a width ranging from about 12″ to about 30″—including all values and sub-ranges there-between.

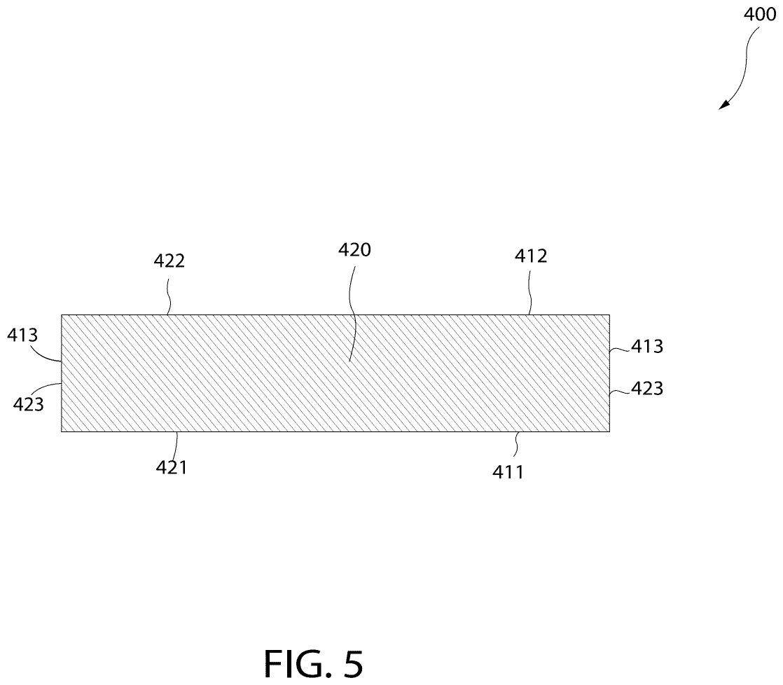

With reference to FIG. 5, in some embodiments, the building panel 400 may include a body 420 having an upper surface 422 opposite a lower surface 421 and a body side surface 423 that extends between the upper surface 422 and the lower surface 421, thereby defining a perimeter of the body 420. The body 420 may have a body thickness that extends from the upper surface 422 to the lower surface 421. The body thickness may range from about 0.4″ to about 1″—including all values and sub-ranges there-between.

The first major surface 411 of the building panel 400 may comprise the lower surface 421 of the body 420. The second major surface 412 of the building panel 400 may comprise the upper surface 422 of the body 420. When the first major surface 411 of the building panel 400 comprises the lower surface 421 of the body 420 and the second major surface 412 of the building panel 400 comprises the upper surface 422 of the body 420, the panel thickness is substantially equal to the body thickness.

In some embodiments, the body 420 may include inorganic materials, including but not limited to inorganic particles. In some embodiments, the inorganic material may be present in an amount ranging from about 1 wt. % to about 99 wt. % (for calcined bodies) based on the total dry weight of the body 420—including all values and sub-ranges there-between. For example, in some embodiments, the inorganic material, such as inorganic particles, may be present in an amount ranging from about 1 wt. % to about 99 wt. %, from about 10 wt. % to about 99 wt. %, from about 20 wt. % to about 99 wt. %, from about 30 wt. % to about 99 wt. %, from about 40 wt. % to about 99 wt. %, from about 50 wt. % to about 99 wt. %, from about 60 wt. % to about 99 wt. %, from about 70 wt. % to about 99 wt. %, from about 80 wt. % to about 99 wt. %, from about 90 wt. % to about 99 wt. %, from about 1 wt. % to about 90 wt. %, from about 10 wt. % to about 90 wt. %, from about 20 wt. % to about 90 wt. %, from about 30 wt. % to about 90 wt. %, from about 40 wt. % to about 90 wt. %, from about 50 wt. % to about 90 wt. %, from about 60 wt. % to about 90 wt. %, from about 70 wt. % to about 90 wt. %, from about 80 wt. % to about 90 wt. %, from about 1 wt. % to about 80 wt. %, from about 10 wt. % to about 80 wt. %, from about 20 wt. % to about 80 wt. %, from about 30 wt. % to about 80 wt. %, from about 40 wt. % to about 80 wt. %, from about 50 wt. % to about 80 wt. %, from about 60 wt. % to about 80 wt. %, from about 70 wt. % to about 80 wt. %, from about 1 wt. % to about 70 wt. %, from about 10 wt. % to about 70 wt. %, from about 20 wt. % to about 70 wt. %, from about 30 wt. % to about 70 wt. %, from about 40 wt. % to about 70 wt. %, from about 50 wt. % to about 70 wt. %, from about 60 wt. % to about 70 wt. %, from about 1 wt. % to about 60 wt. %, from about 10 wt. % to about 60 wt. %, from about 20 wt. % to about 60 wt. %, from about 30 wt. % to about 60 wt. %, from about 40 wt. % to about 60 wt. %, from about 50 wt. % to about 60 wt. %, from about 1 wt. % to about 50 wt. %, from about 10 wt. % to about 50 wt. %, from about 20 wt. % to about 50 wt. %, from about 30 wt. % to about 50 wt. %, from about 40 wt. % to about 50 wt. %, from about 1 wt. % to about 40 wt. %, from about 10 wt. % to about 40 wt. %, from about 20 wt. % to about 40 wt. %, from about 30 wt. % to about 40 wt. %, from about 1 wt. % to about 30 wt. %, from about 10 wt. % to about 30 wt. %, from about 20 wt. % to about 30 wt. %, from about 1 wt. % to about 20 wt. %, from about 10 wt. % to about 20 wt. %, from about 1 wt. % to about 10 wt. %, or any other suitable values or sub-ranges there-between, based on the total dry weight of the body 420.

In some embodiments, the inorganic particles may have an average particle size ranging from about 0.1 μm to about 5 mm—including all values and sub-ranges there-between. For example, in some embodiments, the inorganic particles may have an average particle size ranging from about 0.1 μm to about 5 mm, from about 0.5 μm to about 5 mm, from about 1 μm to about 5 mm, from about 1.5 μm to about 5 mm, from about 2 μm to about 5 mm, from about 3 μm to about 5 mm, from about 4 μm to about 5 μm, from about 0.1 μm to about 4 mm, from about 0.5 μm to about 4 mm, from about 1 μm to about 4 mm, from about 1.5 μm to about 4 mm, from about 2 μm to about 4 mm, from about 3 μm to about 4 mm, from about 0.1 μm to about 3 mm, from about 0.5 μm to about 3 mm, from about 1 μm to about 3 mm, from about 1.5 μm to about 3 mm, from about 2 μm to about 3 mm, from about 0.1 μm to about 2 mm, from about 0.5 μm to about 2 mm, from about 1 μm to about 2 mm, from about 1.5 μm to about 2 mm, from about 0.1 μm to about 1.5 mm, from about 0.5 μm to about 1.5 mm, from about 1 μm to about 1.5 mm, from about 0.1 μm to about 1 mm, from about 0.5 μm to about 1 mm, from about 0.1 μm to about 0.5 mm, or any other suitable values or sub-ranges there-between.

In some embodiments, the inorganic material may include one or more an alkaline earth metal compounds. In some embodiments, the alkaline earth metal compound may include at least one of an alkaline earth metal oxide, an alkaline earth metal sulfate, or combination thereof. In some embodiments, the alkaline earth metal compound may include at least one of a calcium compound, a magnesium compound, or combination thereof. In some embodiments, the alkaline earth metal compound may include at least one of calcium sulfate, magnesium sulfate, magnesium oxide, or combination thereof.

In some embodiments, the alkaline earth metal compound may include a calcium compound. In some embodiments, the calcium compound may include calcium sulfate. In some embodiments, the calcium compound may have an average particle size ranging from about 0.1 μm to about 2,000 μm—including all values and sub-ranges there-between. For example, in some embodiments, the calcium compound may have an average particle size ranging from about 0.1 μm to about 2,000 μm, from about 100 μm to about 2,000 μm, from about 500 μm to about 2,000 μm, from about 1,000 μm to about 2,000 μm, from about 1,500 μm to about 2,000 μm, from about 0.1 μm to about 1,500 μm, from about 100 μm to about 1,500 μm, from about 500 μm to about 1,500 μm, from about 1,000 μm to about 1,500 μm, from about 0.1 μm to about 1,000 μm, from about 100 μm to about 1,000 μm, from about 500 μm to about 1,000 μm, from about 0.1 μm to about 500 μm, from about 100 μm to about 500 μm, from about 0.1 μm to about 100 μm, or any other suitable values or sub-ranges there-between.

In some embodiments, the calcium compound may be present in an amount ranging from about 1 wt. % to about 90 wt. % based on the total dry weight of the body 420—including all values and sub-ranges there-between. For example, in some embodiments, the calcium compound may be present in an amount ranging from about 1 wt. % to about 90 wt. %, from about 10 wt. % to about 90 wt. %, from about 20 wt. % to about 90 wt. %, from about 30 wt. % to about 90 wt. %, from about 40 wt. % to about 90 wt. %, from about 50 wt. % to about 90 wt. %, from about 60 wt. % to about 90 wt. %, from about 70 wt. % to about 90 wt. %, from about 80 wt. % to about 90 wt. %, from about 1 wt. % to about 80 wt. %, from about 10 wt. % to about 80 wt. %, from about 20 wt. % to about 80 wt. %, from about 30 wt. % to about 80 wt. %, from about 40 wt. % to about 80 wt. %, from about 50 wt. % to about 80 wt. %, from about 60 wt. % to about 80 wt. %, from about 70 wt. % to about 80 wt. %, from about 1 wt. % to about 70 wt. %, from about 10 wt. % to about 70 wt. %, from about 20 wt. % to about 70 wt. %, from about 30 wt. % to about 70 wt. %, from about 40 wt. % to about 70 wt. %, from about 50 wt. % to about 70 wt. %, from about 60 wt. % to about 70 wt. %, from about 1 wt. % to about 60 wt. %, from about 10 wt. % to about 60 wt. %, from about 20 wt. % to about 60 wt. %, from about 30 wt. % to about 60 wt. %, from about 40 wt. % to about 60 wt. %, from about 50 wt. % to about 60 wt. %, from about 1 wt. % to about 50 wt. %, from about 10 wt. % to about 50 wt. %, from about 20 wt. % to about 50 wt. %, from about 30 wt. % to about 50 wt. %, from about 40 wt. % to about 50 wt. %, from about 1 wt. % to about 40 wt. %, from about 10 wt. % to about 40 wt. %, from about 20 wt. % to about 40 wt. %, from about 30 wt. % to about 40 wt. %, from about 1 wt. % to about 30 wt. %, from about 10 wt. % to about 30 wt. %, from about 20 wt. % to about 30 wt. %, from about 1 wt. % to about 20 wt. %, from about 10 wt. % to about 20 wt. %, from about 1 wt. % to about 10 wt. %, or any other suitable values or sub-ranges there-between, based on the total dry weight of the body 420.

In some embodiments, the alkaline earth metal compound may include a magnesium compound. In some embodiments, the magnesium compound may be present in an amount ranging from about 0 wt. % to about 75 wt. % based on the total dry weight of the body 420—including all values and sub-ranges there-between. For example, in some embodiments, the magnesium compound may be present in an amount ranging from about 0 wt. % to about 75 wt. %, from about 10 wt. % to about 75 wt. %, from about 20 wt. % to about 75 wt. %, from about 30 wt. % to about 75 wt. %, from about 40 wt. % to about 75 wt. %, from about 50 wt. % to about 75 wt. %, from about 60 wt. % to about 75 wt. %, from about 70 wt. % to about 75 wt. %, from about 0 wt. % to about 70 wt. %, from about 10 wt. % to about 70 wt. %, from about 20 wt. % to about 70 wt. %, from about 30 wt. % to about 70 wt. %, from about 40 wt. % to about 70 wt. %, from about 50 wt. % to about 70 wt. %, from about 60 wt. % to about 70 wt. %, from about 0 wt. % to about 60 wt. %, from about 10 wt. % to about 60 wt. %, from about 20 wt. % to about 60 wt. %, from about 30 wt. % to about 60 wt. %, from about 40 wt. % to about 60 wt. %, from about 50 wt. % to about 60 wt. %, from about 0 wt. % to about 50 wt. %, from about 10 wt. % to about 50 wt. %, from about 20 wt. % to about 50 wt. %, from about 30 wt. % to about 50 wt. %, from about 40 wt. % to about 50 wt. %, from about 0 wt. % to about 40 wt. %, from about 10 wt. % to about 40 wt. %, from about 20 wt. % to about 40 wt. %, from about 30 wt. % to about 40 wt. %, from about 0 wt. % to about 30 wt. %, from about 10 wt. % to about 30 wt. %, from about 20 wt. % to about 30 wt. %, from about 0 wt. % to about 20 wt. %, from about 10 wt. % to about 20 wt. %, from about 0 wt. % to about 10 wt. %, or any other suitable values or sub-ranges there-between, based on the total dry weight of the body 420.

In some embodiments, the magnesium compound may have an average particle size ranging from about 0.5 μm to about 1,000 μm—including all values and sub-ranges there-between. For example, the magnesium compound may have an average particle size ranging from about 0.5 μm to about 1,000 μm, from about 250 μm to about 1,000 μm, from about 500 μm to about 1,000 μm, from about 750 μm to about 1,000 μm, from about 0.5 μm to about 750 μm, from about 250 μm to about 750 μm, from about 500 μm to about 750 μm, from about 0.5 μm to about 500 μm, from about 250 μm to about 500 μm, from about 0.5 μm to about 250 μm, or any other suitable values or sub-ranges there-between.

In some embodiments, the magnesium compound may include at least one of magnesium oxide, magnesium sulfate, or combination thereof. In some embodiments, the magnesium oxide may be present in an amount ranging from about 0 wt. % to about 50 wt. % based on the total dry weight of the body 420—including all values and sub-ranges there-between. For example, in some embodiments, the magnesium oxide may be present in an amount ranging from about 0 wt. % to about 50 wt. %, from about 10 wt. % to about 50 wt. %, from about 20 wt. % to about 50 wt. %, from about 30 wt. % to about 50 wt. %, from about 40 wt. % to about 50 wt. %, from about 0 wt. % to about 40 wt. %, from about 10 wt. % to about 40 wt. %, from about 20 wt. % to about 40 wt. %, from about 30 wt. % to about 40 wt. %, from about 0 wt. % to about 30 wt. %, from about 10 wt. % to about 30 wt. %, from about 20 wt. % to about 30 wt. %, from about 0 wt. % to about 20 wt. %, from about 10 wt. % to about 20 wt. %, from about 0 wt. % to about 10 wt. %, or any other suitable values or sub-ranges there-between, based on the total dry weight of the body 420.

In some embodiments, the magnesium oxide may have an average particle size ranging from about 0.5 μm to about 1,000 μm—including all values and sub-ranges there-between. For example, in some embodiments, the magnesium oxide may have an average particle size ranging from about 0.5 μm to about 1,000 μm, from about 250 μm to about 1,000 μm, from about 500 μm to about 1,000 μm, from about 750 μm to about 1,000 μm, from about 0.5 μm to about 750 μm, from about 250 μm to about 750 μm, from about 500 μm to about 750 μm, from about 0.5 μm to about 500 μm, from about 250 μm to about 500 μm, from about 0.5 μm to about 250 μm, or any other suitable values or sub-ranges there-between.

In some embodiments, the magnesium sulfate may be present in an amount ranging from about 0 wt. % to about 20 wt. % based on the total dry weight of the body 420—including all values and sub-ranges there-between. For example, in some embodiments, the magnesium sulfate may be present in an amount ranging from about 0 wt. % to about 20 wt. %, from about 5 wt. % to about 20 wt. %, from about 10 wt. % to about 20 wt. %, from about 15 wt. % to about 20 wt. %, from about 0 wt. % to about 15 wt. %, from about 5 wt. % to about 15 wt. %, from about 10 wt. % to about 15 wt. %, from about 0 wt. % to about 10 wt. %, from about 5 wt. % to about 10 wt. %, from about 0 wt. % to about 5 wt. %, or any other suitable values or sub-ranges there-between, based on the total dry weight of the body 420.

In some embodiments, the building panel 400 may include a gypsum board, and the inorganic material of the body 420 may include calcium sulfate. In some embodiments, the building panel 400 may include a cementitious material based panel, and the inorganic material of the body 420 may include at least one of magnesium oxide, magnesium sulfate, or other cementitious materials.

In some embodiments, the inorganic material of the body 420 may further include a metal silicate. In some embodiments, the metal silicate may include at least one of an alkaline metal silicate, where the alkali moiety includes at least one of sodium, potassium, or lithium. The alkaline metal silicate may be present in an amount ranging from about 0 wt. % to about 30 wt. % based on the total dry weight of the body 420—including all values and sub-ranges there-between. In some embodiments, the alkaline metal silicate may have an average particle size ranging from about 0.1 μm to about 150 μm—including all values and sub-ranges there-between.

In some embodiments, the inorganic material of the body 420 may further include at least one of limestone, bassanite, aluminum sulfate, zinc sulfate, zinc oxide, aluminum oxide, aluminum trioxide, titanium oxide, aluminum silicates, montmorillonite, or bentonite. In some embodiments, including but not limited to cementitious material based building panels, the inorganic material of the body 420 may further include at least one of silica, pozzolan, calcium oxide, calcium hydroxide, calcium silicate, calcium ferrous silicate, metakaolin, nepheline syenite, alabaster, or asphalt.

In some embodiments, the body 420 may further include biochar, similar to the biochar described above with reference to body 120. In some embodiments, the biochar may be present in an amount ranging from about 10 wt. % to about 40 wt. % based on the total dry weight of the body 420—including all values and sub-ranges there-between. For example, in some embodiments, the biochar may be present in an amount ranging from about 10 wt. % to about 40 wt. %, from about 13 wt. % to about 40 wt. %, from about 17 wt. % to about 40 wt. %, from about 20 wt. % to about 40 wt. %, from about 23 wt. % to about 40 wt. %, from about 27 wt. % to about 40 wt. %, from about 30 wt. % to about 40 wt. %, from about 33 wt. % to about 40 wt. %, from about 37 wt. % to about 40 wt. %, from about 10 wt. % to about 37 wt. %, from about 13 wt. % to about 37 wt. %, from about 17 wt. % to about 37 wt. %, from about 20 wt. % to about 37 wt. %, from about 23 wt. % to about 37 wt. %, from about 27 wt. % to about 37 wt. %, from about 30 wt. % to about 37 wt. %, from about 33 wt. % to about 37 wt. %, from about 10 wt. % to about 33 wt. %, from about 13 wt. % to about 33 wt. %, from about 17 wt. % to about 33 wt. %, from about 20 wt. % to about 33 wt. %, from about 23 wt. % to about 33 wt. %, from about 27 wt. % to about 33 wt. %, from about 30 wt. % to about 33 wt. %, from about 10 wt. % to about 30 wt. %, from about 13 wt. % to about 30 wt. %, from about 17 wt. % to about 30 wt. %, from about 20 wt. % to about 30 wt. %, from about 23 wt. % to about 30 wt. %, from about 27 wt. % to about 30 wt. %, from about 10 wt. % to about 27 wt. %, from about 13 wt. % to about 27 wt. %, from about 17 wt. % to about 27 wt. %, from about 20 wt. % to about 27 wt. %, from about 23 wt. % to about 27 wt. %, from about 10 wt. % to about 23 wt. %, from about 13 wt. % to about 23 wt. %, from about 17 wt. % to about 23 wt. %, from about 20 wt. % to about 23 wt. %, from about 10 wt. % to about 20 wt. %, from about 13 wt. % to about 20 wt. %, from about 17 wt. % to about 20 wt. %, from about 10 wt. % to about 17 wt. %, from about 13 wt. % to about 17 wt. %, from about 10 wt. % to about 13 wt. %, or any other suitable values or sub-ranges there-between, based on the total dry weight of the body 420.

In some embodiments, the biochar may have an average particle size ranging from about 0.1 mm to about 5 mm—including all sizes and sub-ranges there-between. For example, in some embodiments, the biochar may have an average particle size ranging from about 0.1 mm to about 5 mm, from about 0.5 mm to about 5 mm, from about 1 mm to about 5 mm, from about 1.5 mm to about 5 mm, from about 2 mm to about 5 mm, from about 2.5 mm to about 5 mm, from about 3 mm to about 5 mm, from about 3.5 mm to about 5 mm, from about 4 mm to about 5 mm, from about 4.5 mm to about 5 mm, from about 0.1 mm to about 4.5 mm, from about 0.5 mm to about 4.5 mm, from about 1 mm to about 4.5 mm, from about 1.5 mm to about 4.5 mm, from about 2 mm to about 4.5 mm, from about 2.5 mm to about 4.5 mm, from about 3 mm to about 4.5 mm, from about 3.5 mm to about 4.5 mm, from about 4 mm to about 4.5 mm, from about 0.1 mm to about 4 mm, from about 0.5 mm to about 4 mm, from about 1 mm to about 4 mm, from about 1.5 mm to about 4 mm, from about 2 mm to about 4 mm, from about 2.5 mm to about 4 mm, from about 3 mm to about 4 mm, from about 3.5 mm to about 4 mm, from about 0.1 mm to about 3.5 mm, from about 0.5 mm to about 3.5 mm, from about 1 mm to about 3.5 mm, from about 1.5 mm to about 3.5 mm, from about 2 mm to about 3.5 mm, from about 2.5 mm to about 3.5 mm, from about 3 mm to about 3.5 mm, from about 0.1 mm to about 3 mm, from about 0.5 mm to about 3 mm, from about 1 mm to about 3 mm, from about 1.5 mm to about 3 mm, from about 2 mm to about 3 mm, from about 2.5 mm to about 3 mm, from about 0.1 mm to about 2.5 mm, from about 0.5 mm to about 2.5 mm, from about 1 mm to about 2.5 mm, from about 1.5 mm to about 2.5 mm, from about 2 mm to about 2.5 mm, from about 0.1 mm to about 2 mm, from about 0.5 mm to about 2 mm, from about 1 mm to about 2 mm, from about 1.5 mm to about 2 mm, from about 0.1 mm to about 1.5 mm, from about 0.5 mm to about 1.5 mm, from about 1 mm to about 1.5 mm, from about 0.1 mm to about 1 mm, from about 0.5 mm to about 1 mm, from about 0.1 mm to about 0.5 mm, or any other suitable values or sub-ranges there-between.

In some embodiments, the biochar may have a density ranging from about 3 pounds per cubic foot (pcf) to about 18 pcf. For example, in some embodiments, the biochar may have a density ranging from about 3 pcf to about 18 pcf, from about 5 pcf to about 18 pcf, from about 7 pcf to about 18 pcf, from about 9 pcf to about 18 pcf, from about 11 pcf to about 18 pcf, from about 13 pcf to about 18 pcf, from about 15 pcf to about 18 pcf, from about 17 pcf to about 18 pcf, from about 3 pcf to about 17 pcf, from about 5 pcf to about 17 pcf, from about 7 pcf to about 17 pcf, from about 9 pcf to about 17 pcf, from about 11 pcf to about 17 pcf, from about 13 pcf to about 17 pcf, from about 15 pcf to about 17 pcf, from about 3 pcf to about 15 pcf, from about 5 pcf to about 15 pcf, from about 7 pcf to about 15 pcf, from about 9 pcf to about 15 pcf, from about 11 pcf to about 15 pcf, from about 13 pcf to about 15 pcf, from about 3 pcf to about 13 pcf, from about 5 pcf to about 13 pcf, from about 7 pcf to about 13 pcf, from about 9 pcf to about 13 pcf, from about 11 pcf to about 13 pcf, from about 3 pcf to about 11 pcf, from about 5 pcf to about 11 pcf, from about 7 pcf to about 11 pcf, from about 9 pcf to about 11 pcf, from about 3 pcf to about 9 pcf, from about 5 pcf to about 9 pcf, from about 7 pcf to about 9 pcf, from about 3 pcf to about 7 pcf, from about 5 pcf to about 7 pcf, from about 3 pcf to about 5 pcf, or any other suitable values or sub-ranges there-between.

In some embodiments, the body 420 may further include a flame retardant, similar to the flame retardant discussed above with reference to the body 120. In some embodiments, the flame retardant may include an active filler flame retardant, similar to the flame retardant discussed above with reference to the body 120. In some embodiments, the flame retardant may decompose endothermically. In some embodiments, the flame retardant may decompose endothermically at an elevated temperature ranging from about 200° C. to about 325° C. Depending on the particular flame retardant, in some embodiments, the flame retardant may decompose at an elevated temperature ranging from about 200° C. to about 325° C., from about 225° C. to about 325° C., from about 250° C. to about 325° C., from about 275° C. to about 325° C., from about 300° C. to about 325° C., 200° C. to about 300° C., from about 225° C. to about 300° C., from about 250° C. to about 300° C., from about 275° C. to about 300° C., 200° C. to about 275° C., from about 225° C. to about 275° C., from about 250° C. to about 275° C., 200° C. to about 250° C., from about 225° C. to about 250° C., 200° C. to about 225° C., or any other suitable values or sub-ranges there-between. In some embodiments, upon decomposition, the flame retardant may emit water (H2O), such as water vapor. In some embodiments, the flame retardant may include at least one of colemanite, aluminum hydroxide, magnesium hydroxide, boehmite, hydrous or calcined clay, calcium carbonate, talc, feldspar, or a combination of two or more thereof.

In some embodiments, the flame retardant may be present in the body 420 in an amount ranging from about 1 wt. % to about 15 wt. % based on the total dry weight of the body 420—including all values and sub-ranges therebetween. For example, in some embodiments, the flame retardant may be present in the body 420 in an amount ranging from about 1 wt. % to about 15 wt. %, from about 3 wt. % to about 15 wt. %, from about 5 wt. % to about 15 wt. %, from about 7 wt. % to about 15 wt. %, from about 9 wt. % to about 15 wt. %, from about 11 wt. % to about 15 wt. %, from about 13 wt. % to about 15 wt. %, from about 1 wt. % to about 13 wt. %, from about 3 wt. % to about 13 wt. %, from about 5 wt. % to about 13 wt. %, from about 7 wt. % to about 13 wt. %, from about 9 wt. % to about 13 wt. %, from about 11 wt. % to about 13 wt. %, from about 1 wt. % to about 11 wt. %, from about 3 wt. % to about 11 wt. %, from about 5 wt. % to about 11 wt. %, from about 7 wt. % to about 11 wt. %, from about 9 wt. % to about 11 wt. %, from about 1 wt. % to about 9 wt. %, from about 3 wt. % to about 9 wt. %, from about 5 wt. % to about 9 wt. %, from about 7 wt. % to about 9 wt. %, from about 1 wt. % to about 7 wt. %, from about 3 wt. % to about 7 wt. %, from about 5 wt. % to about 7 wt. %, from about 1 wt. % to about 5 wt. %, from about 3 wt. % to about 5 wt. %, or from about 1 wt. % to about 3 wt. %, or any other suitable values or sub-ranges there-between, based on the total dry weight of the body 420.

In some embodiments, the flame retardant may have an average particle size ranging from about 1 μm to about 100 μm—including all values and sub-ranges there-between. For example, in some embodiments, the flame retardant may have an average particle size ranging from about 1 μm to about 100 μm, from about 25 μm to about 100 μm, from about 50 μm to about 100 μm, from about 75 μm to about 100 μm, from about 1 μm to about 75 μm, from about 25 μm to about 75 μm, from about 50 μm to about 75 μm, from about 1 μm to about 50 μm, from about 25 μm to about 50 μm, from about 1 μm to about 25 μm, or any other suitable values or sub-ranges there-between.

In some embodiments, the body 420 may further include fibers. In some embodiments, the fibers may include organic fibers. The organic fibers may be present in an amount ranging from about 4 wt. % to about 30 wt. % based on the total dry weight of the body 420—including all values and sub-ranges there-between. For example, in some embodiments, the organic fibers may be present in an amount ranging from about 4 wt. % to about 30 wt. %, from about 8 wt. % to about 30 wt. %, from about 12 wt. % to about 30 wt. %, from about 16 wt. % to about 30 wt. %, from about 20 wt. % to about 30 wt. %, from about 24 wt. % to about 30 wt. %, from about 28 wt. % to about 30 wt. %, from about 4 wt. % to about 28 wt. %, from about 8 wt. % to about 28 wt. %, from about 12 wt. % to about 28 wt. %, from about 16 wt. % to about 28 wt. %, from about 20 wt. % to about 28 wt. %, from about 24 wt. % to about 28 wt. %, from about 4 wt. % to about 24 wt. %, from about 8 wt. % to about 24 wt. %, from about 12 wt. % to about 24 wt. %, from about 16 wt. % to about 24 wt. %, from about 20 wt. % to about 24 wt. %, from about 4 wt. % to about 20 wt. %, from about 8 wt. % to about 20 wt. %, from about 12 wt. % to about 20 wt. %, from about 16 wt. % to about 20 wt. %, from about 4 wt. % to about 16 wt. %, from about 8 wt. % to about 16 wt. %, from about 12 wt. % to about 16 wt. %, from about 4 wt. % to about 12 wt. %, from about 8 wt. % to about 12 wt. %, from about 4 wt. % to about 8 wt. %, or any other suitable values or sub-ranges there-between, based on the total dry weight of the body 420. In some embodiments, the organic fibers may include macroscopic cellulosic fibers (e.g., paper fiber—such as newspaper, hemp fiber, jute fiber, flax fiber, wood fiber, or other natural fibers), protein fibers (e.g., sheep wool), and combinations thereof.

In some embodiments, the fibers may further include inorganic fibers. The inorganic fibers may be present in an amount ranging from about 1 wt. % to about 80 wt. % based on the total dry weight of the body 420—including all values and sub-ranges there-between. For example, in some embodiments, the inorganic fibers may be present in an amount ranging from about 1 wt. % to about 80 wt. %, from about 10 wt. % to about 80 wt. %, from about 20 wt. % to about 80 wt. %, from about 40 wt. % to about 80 wt. %, from about 60 wt. % to about 80 wt. %, from about 1 wt. % to about 60 wt. %, from about 10 wt. % to about 60 wt. %, from about 20 wt. % to about 60 wt. %, from about 40 wt. % to about 60 wt. %, from about 1 wt. % to about 40 wt. %, from about 10 wt. % to about 40 wt. %, from about 20 wt. % to about 40 wt. %, from about 1 wt. % to about 20 wt. %, from about 10 wt. % to about 20 wt. %, from about 1 wt. % to about 10 wt. %, or any other suitable values or sub-ranges there-between, based on the total dry weight of the body 420. In some embodiments, the inorganic fibers may include mineral wool (also referred to as slag wool), rock wool, stone wool, glass fibers, polymer fibers, and combinations thereof. Non-limiting examples of polymer fibers include polyester fiber, polyethylene fiber, aramid fiber (e.g., aromatic polyamide fiber), polypropylene fiber, and combinations thereof.

In some embodiments, the inorganic material, such as the inorganic particles, and the biochar may be present in a weight ratio ranging from about 1.5:1 to about 6:1—including all values and sub-ranges there-between. For example, in some embodiments, the inorganic material, such as the inorganic particles, and the biochar may be present in a weight ratio ranging from about 1.5:1 to about 6:1, from about 2:1 to about 6:1, from about 2.5:1 to about 6:1, from about 3:1 to about 6:1, from about 3.5:1 to about 6:1, from about 4:1 to about 6:1, from about 4.5:1 to about 6:1, from about 5:1 to about 6:1, from about 5.5:1 to about 6:1, 1.5:1 to about 5.5:1, from about 2:1 to about 5.5:1, from about 2.5:1 to about 5.5:1, from about 3:1 to about 5.5:1, from about 3.5:1 to about 5.5:1, from about 4:1 to about 5.5:1, from about 4.5:1 to about 5.5:1, from about 5:1 to about 5.5:1, 1.5:1 to about 5:1, from about 2:1 to about 5:1, from about 2.5:1 to about 5:1, from about 3:1 to about 5:1, from about 3.5:1 to about 5:1, from about 4:1 to about 5:1, from about 4.5:1 to about 5:1, 1.5:1 to about 4.5:1, from about 2:1 to about 4.5:1, from about 2.5:1 to about 4.5:1, from about 3:1 to about 4.5:1, from about 3.5:1 to about 4.5:1, from about 4:1 to about 4.5:1, 1.5:1 to about 4:1, from about 2:1 to about 4:1, from about 2.5:1 to about 4:1, from about 3:1 to about 4:1, from about 3.5:1 to about 4:1, 1.5:1 to about 3.5:1, from about 2:1 to about 3.5:1, from about 2.5:1 to about 3.5:1, from about 3:1 to about 3.5:1, 1.5:1 to about 3:1, from about 2:1 to about 3:1, from about 2.5:1 to about 3:1, 1.5:1 to about 2.5:1, from about 2:1 to about 2.5:1, 1.5:1 to about 2:1, or any other suitable values or sub-ranges there-between.

In some embodiments, the inorganic material, such as the inorganic particles, and the biochar may be present in a weight ratio ranging from about 2:1 to about 4:1—including all values and sub-ranges there-between. In some embodiments, the inorganic material, such as the inorganic particles, and the biochar may be present in a weight ratio ranging from about 2.5:1 to about 3.5:1—including all values and sub-ranges there-between. A lower inorganic material to biochar ratio (or a higher biochar content) allows greater carbon footprint reduction to be achieved without negatively impacting mechanical and/or acoustic characteristics of the building panels.

In some embodiments, the inorganic material, such as the inorganic particles and the flame retardant may be present in a weight ratio ranging from about 3:1 to about 12:1—including all values and sub-ranges there-between. For example, in some embodiments, the inorganic material, such as the inorganic particles and the flame retardant may be present in a weight ratio ranging from about 3:1 to about 12:1, from about 4:1 to about 12:1, from about 5:1 to about 12:1, from about 6:1 to about 12:1, from about 7:1 to about 12:1, from about 8:1 to about 12:1, from about 9:1 to about 12:1, from about 10:1 to about 12:1, from about 11:1 to about 12:1, from about 3:1 to about 11:1, from about 4:1 to about 11:1, from about 5:1 to about 11:1, from about 6:1 to about 11:1, from about 7:1 to about 11:1, from about 8:1 to about 11:1, from about 9:1 to about 11:1, from about 10:1 to about 11:1, from about 3:1 to about 10:1, from about 4:1 to about 10:1, from about 5:1 to about 10:1, from about 6:1 to about 10:1, from about 7:1 to about 10:1, from about 8:1 to about 10:1, from about 9:1 to about 10:1, from about 3:1 to about 9:1, from about 4:1 to about 9:1, from about 5:1 to about 9:1, from about 6:1 to about 9:1, from about 7:1 to about 9:1, from about 8:1 to about 9:1, from about 3:1 to about 8:1, from about 4:1 to about 8:1, from about 5:1 to about 8:1, from about 6:1 to about 8:1, from about 7:1 to about 8:1, from about 3:1 to about 7:1, from about 4:1 to about 7:1, from about 5:1 to about 7:1, from about 6:1 to about 7:1, from about 3:1 to about 6:1, from about 4:1 to about 6:1, from about 5:1 to about 6:1, from about 3:1 to about 5:1, from about 4:1 to about 5:1, from about 3:1 to about 4:1, or any other suitable values or sub-ranges there-between.

In some embodiments, the inorganic material, such as the inorganic particles and the flame retardant may be present in a weight ratio ranging from about 4:1 to about 8:1—including all values and sub-ranges there-between. In some embodiments, the inorganic material, such as the inorganic particles and the flame retardant may be present in a weight ratio ranging from about 5:1 to about 7:1—including all values and sub-ranges there-between.

In some embodiments, the biochar and the flame retardant may be present in a weight ratio ranging from about 1.5:1 to about 4:1—including all values and sub-ranges there-between. The building panels described herein may allow high biochar-to-flame-retardant weight ratios to be implemented to keep the manufacturing cost low while maintaining desirable fire resistance. In some embodiments, the biochar and the flame retardant may be present in a weight ratio ranging from about 1:1 to about 20:1—including all values and sub-ranges there-between.

For example, in some embodiments, the biochar and the flame retardant may be present in a weight ratio ranging from about 1:1 to about 20:1, from about 1.5:1 to about 20:1, from about 2:1 to about 20:1, from about 2.5:1 to about 20:1, from about 3:1 to about 20:1, from about 3.5:1 to about 20:1, from about 4:1 to about 20:1, from about 5:1 to about 20:1, from about 7.5:1 to about 20:1, from about 10:1 to about 20:1, from about 15:1 to about 20:1, 1:1 to about 15:1, from about 1.5:1 to about 15:1, from about 2:1 to about 15:1, from about 2.5:1 to about 15:1, from about 3:1 to about 15:1, from about 3.5:1 to about 15:1, from about 4:1 to about 15:1, from about 5:1 to about 15:1, from about 7.5:1 to about 15:1, from about 10:1 to about 15:1, 1:1 to about 10:1, from about 1.5:1 to about 10:1, from about 2:1 to about 10:1, from about 2.5:1 to about 10:1, from about 3:1 to about 10:1, from about 3.5:1 to about 10:1, from about 4:1 to about 10:1, from about 5:1 to about 10:1, from about 7.5:1 to about 10:1, from about 10:1 to about 10:1, 1:1 to about 7.5:1, from about 1.5:1 to about 7.5:1, from about 2:1 to about 7.5:1, from about 2.5:1 to about 7.5:1, from about 3:1 to about 7.5:1, from about 3.5:1 to about 7.5:1, from about 4:1 to about 7.5:1, from about 5:1 to about 7.5:1, 1:1 to about 5:1, from about 1.5:1 to about 5:1, from about 2:1 to about 5:1, from about 2.5:1 to about 5:1, from about 3:1 to about 5:1, from about 3.5:1 to about 5:1, from about 4:1 to about 5:1, 1:1 to about 4:1, from about 1.5:1 to about 4:1, from about 2:1 to about 4:1, from about 2.5:1 to about 4:1, from about 3:1 to about 4:1, from about 3.5:1 to about 4:1, 1:1 to about 3.5:1, from about 1.5:1 to about 3.5:1, from about 2:1 to about 3.5:1, from about 2.5:1 to about 3.5:1, from about 3:1 to about 3.5:1, 1:1 to about 3:1, from about 1.5:1 to about 3:1, from about 2:1 to about 3:1, from about 2.5:1 to about 3:1, 1:1 to about 2.5:1, from about 1.5:1 to about 2.5:1, from about 2:1 to about 2.5:1, 1:1 to about 2:1, from about 1.5:1 to about 2:1, 1:1 to about 1.5:1, or any other suitable values or sub-ranges there-between.

In some embodiments, the body 420 may have airflow properties that may allow the building panel 400 to function as an acoustical building panel. In some embodiments, the addition of biochar into acoustical building panels may have a neutral or positive impact on the acoustic performance due to the porous nature and the high skeletal density of biochar.

In some embodiments, perforations may be formed in the body 420 to further enhance the airflow properties and the acoustical performance of the building panel 400. In some embodiments, the body 420 may include a plurality of perforations that extend continuously from the upper surface 422 to the lower surface 421 of the body 420, forming air passageways that provide for fluid communication through the body 420 between the upper surface 422 and the lower surface 421.

In some embodiments, the perforations may have an average diameter ranging from about 0.5 mm to about 100 mm—including all values and sub-ranges there-between. For example, in some embodiments, the perforations may have a diameter ranging from, e.g., about 0.5 mm to about 50 mm, about 0.5 mm to about 40 mm, about 0.5 mm to about 30 mm, about 0.5 mm to about 20 mm, about 0.5 mm to about 10 mm, about 0.5 mm to about 8 mm, about 0.5 mm to about 6 mm, about 0.5 mm to about 4 mm, about 0.5 mm to about 2 mm, or about 0.5 mm to about 1 mm, to achieve desired acoustical performance and/or any other desired properties. In some embodiments, the perforations may have a uniform size (e.g., diameter). In some embodiments, the perforations may have non-uniform, varied sizes.

In some embodiments, the perforations may be present in a perforation density (the number of the perforations within each unit area) ranging from about 1 perforation per ft² to about 100 perforations per ft²—including all values and sub-ranges there-between. For example, in some embodiments, the perforations may be present in a perforation density ranging from about 1 perforation per ft² to about 100 perforations per ft², from about 25 perforations per ft² to about 100 perforations per ft², from about 50 perforations per ft² to about 100 perforations per ft², from about 75 perforations per ft² to about 100 perforations per ft², 1 perforation per ft² to about 75 perforations per ft², from about 25 perforations per ft² to about 75 perforations per ft², from about 50 perforations per ft² to about 75 perforations per ft², 1 perforation per ft² to about 50 perforations per ft², from about 25 perforations per ft² to about 50 perforations per ft², 1 perforation per ft² to about 25 perforations per ft², or any other suitable values or sub-ranges there-between.

In some embodiments, the body 420 may exhibit an airflow resistance ranging from about 200 MKS Rayls to about 40,000 MKS Rayls measured between the upper surface 422 and the lower surface 421—including all values and sub-ranges there-between. In some embodiments, the building panel 400 may exhibit an airflow resistance ranging from about 200 MKS Rayls to about 40,000 MKS Rayls as measured between the first major surface 411 and the second major surface 412—including all values and sub-ranges there-between. In some embodiments, the building panel 400 may exhibit an NRC of at least about 0.5 as measured between the first major surface 411 and the second major surface 412. In some embodiments, the building panel 400 may exhibit an NRC ranging from about 0.60 to about 0.99 as measured between the first major surface 411 and the second major surface 412—including all values and sub-ranges there-between.

The body 420 in the dry-state may have a bulk density ranging from about 0.03 g/cm³ to about 0.25 g/cm³—including all values and sub-ranges there-between. The term “bulk density” refers to the density as measured relative to the total volume V_{Total} of the body 420—whereby V_{Total} is defined by the volume resulting from the panel length, panel width and panel thickness. The V_{Total} includes the volume occupied by the skeleton of the body 420 (i.e., the volume occupied by materials forming the body 420, including the inorganic particles, the biochar, the flame retardant, the organic fibers, etc.) as well as the volume occupied by the voids created by the perforations extending through the body 420 of the building panel 400.

In some embodiments, the body 420 in the dry-state may have a bulk density ranging from about 0.03 g/cm³ to about 0.25 g/cm³, from about 0.05 g/cm³ to about 0.25 g/cm³, from about 0.07 g/cm³ to about 0.25 g/cm³, from about 0.09 g/cm³ to about 0.25 g/cm³, from about 0.11 g/cm³ to about 0.25 g/cm³, from about 0.13 g/cm³ to about 0.25 g/cm³, from about 0.15 g/cm³ to about 0.25 g/cm³, from about 0.17 g/cm³ to about 0.25 g/cm³, from about 0.19 g/cm³ to about 0.25 g/cm³, from about 0.21 g/cm³ to about 0.25 g/cm³, from about 0.23 g/cm³ to about 0.25 g/cm³, from about 0.03 g/cm³ to about 0.23 g/cm³, from about 0.05 g/cm³ to about 0.23 g/cm³, from about 0.07 g/cm³ to about 0.23 g/cm³, from about 0.09 g/cm³ to about 0.23 g/cm³, from about 0.11 g/cm³ to about 0.23 g/cm³, from about 0.13 g/cm³ to about 0.23 g/cm³, from about 0.15 g/cm³ to about 0.23 g/cm³, from about 0.17 g/cm³ to about 0.23 g/cm³, from about 0.19 g/cm³ to about 0.23 g/cm³, from about 0.21 g/cm³ to about 0.23 g/cm³, from about 0.03 g/cm³ to about 0.21 g/cm³, from about 0.05 g/cm³ to about 0.21 g/cm³, from about 0.07 g/cm³ to about 0.21 g/cm³, from about 0.09 g/cm³ to about 0.21 g/cm³, from about 0.11 g/cm³ to about 0.21 g/cm³, from about 0.13 g/cm³ to about 0.21 g/cm³, from about 0.15 g/cm³ to about 0.21 g/cm³, from about 0.17 g/cm³ to about 0.21 g/cm³, from about 0.19 g/cm³ to about 0.21 g/cm³, from about 0.03 g/cm³ to about 0.19 g/cm³, from about 0.05 g/cm³ to about 0.19 g/cm³, from about 0.07 g/cm³ to about 0.19 g/cm³, from about 0.09 g/cm³ to about 0.19 g/cm³, from about 0.11 g/cm³ to about 0.19 g/cm³, from about 0.13 g/cm³ to about 0.19 g/cm³, from about 0.15 g/cm³ to about 0.19 g/cm³, from about 0.17 g/cm³ to about 0.19 g/cm³, from about 0.03 g/cm³ to about 0.17 g/cm³, from about 0.05 g/cm³ to about 0.17 g/cm³, from about 0.07 g/cm³ to about 0.17 g/cm³, from about 0.09 g/cm³ to about 0.17 g/cm³, from about 0.11 g/cm³ to about 0.17 g/cm³, from about 0.13 g/cm³ to about 0.17 g/cm³, from about 0.15 g/cm³ to about 0.17 g/cm³, from about 0.03 g/cm³ to about 0.15 g/cm³, from about 0.05 g/cm³ to about 0.15 g/cm³, from about 0.07 g/cm³ to about 0.15 g/cm³, from about 0.09 g/cm³ to about 0.15 g/cm³, from about 0.11 g/cm³ to about 0.15 g/cm³, from about 0.13 g/cm³ to about 0.15 g/cm³, from about 0.03 g/cm³ to about 0.13 g/cm³, from about 0.05 g/cm³ to about 0.13 g/cm³, from about 0.07 g/cm³ to about 0.13 g/cm³, from about 0.09 g/cm³ to about 0.13 g/cm³, from about 0.11 g/cm³ to about 0.13 g/cm³, from about 0.03 g/cm³ to about 0.11 g/cm³, from about 0.05 g/cm³ to about 0.11 g/cm³, from about 0.07 g/cm³ to about 0.11 g/cm³, from about 0.09 g/cm³ to about 0.11 g/cm³, from about 0.03 g/cm³ to about 0.09 g/cm³, from about 0.05 g/cm³ to about 0.09 g/cm³, from about 0.07 g/cm³ to about 0.09 g/cm³, from about 0.03 g/cm³ to about 0.07 g/cm³, from about 0.05 g/cm³ to about 0.07 g/cm³, from about 0.03 g/cm³ to about 0.05 g/cm³, or any other suitable values or sub-ranges there-between.

The body 420 in the dry-state may have a skeletal density ranging from about 1 g/cm³ to about 2.6 g/cm³—including all values and sub-ranges there-between. The term “skeletal density” refers to the density as measured relative to the body total volume V_{Total} of the body 420—whereby V_{Total} is defined by the volume resulting from the panel length, panel width and panel thickness minus the volume occupied by the voids created by the perforations 200.

In some embodiments, the body 420 in the dry-state may have a skeletal density ranging from about 1 g/cm³ to about 2.6 g/cm³, from about 1.3 g/cm³ to about 2.6 g/cm³, from about 1.6 g/cm³ to about 2.6 g/cm³, from about 2 g/cm³ to about 2.6 g/cm³, from about 2.3 g/cm³ to about 2.6 g/cm³, from about 1 g/cm³ to about 2.3 g/cm³, from about 1.3 g/cm³ to about 2.3 g/cm³, from about 1.6 g/cm³ to about 2.3 g/cm³, from about 2 g/cm³ to about 2.3 g/cm³, from about 1 g/cm³ to about 2 g/cm³, from about 1.3 g/cm³ to about 2 g/cm³, from about 1.6 g/cm³ to about 2 g/cm³, from about 1 g/cm³ to about 1.6 g/cm³, from about 1.3 g/cm³ to about 1.6 g/cm³, from about 1 g/cm³ to about 1.3 g/cm³, or any other suitable values or sub-ranges there-between.

In some embodiments, the building panel 400 may be manufactured according to the following methodology. In some embodiments, the inorganic particles, the biochar, the flame retardant, fibers (e.g., organic fibers), and a liquid carrier, such as water, may be mixed to form a blend. The liquid carrier may be present in an amount ranging from about 94 wt. % to about 99 wt. % based on the total weight of the blend—including all values and sub-ranges there-between.

The blend may be shaped or processed into a web in the wet state. The web in the wet state may then be heated at an elevated temperature ranging from about 100° C. to about 200° C. —including all values and sub-ranges there-between—to dry or harden and cut into size, forming the body 420 in the dry state.

In some embodiments, during the shaping process, a mold may be used. In some embodiments, the mold may include structures or geometrical shapes that would create through-holes or perforations in the body 420.

In some embodiments, the body 420 may be formed without perforations in the above mentioned process, and perforations may be subsequently formed or machined in the body 420 by drilling, punching, or any suitable methods.

The following examples are prepared in accordance with the present invention. The present invention is not limited to the examples described herein.

### EXAMPLES

### Experiment 1

A first experiment was performed to test the impact on strength and porosity of the panels according to the present invention. Each of the panels comprised a body formed of a formulation set forth below in Table 1—each amount listed is in weight percentage (wt. %).

TABLE 1

| | Comp. | | | |
|---|---|---|---|---|
| | Ex. 1 | Ex. 1 | Ex. 2 | Ex. 3 |
| Mineral Wool | 70.0 | 70.0 | 70.0 | 60.0 |
| Biochar 1 | — | 19.0 | — | 19.0 |
| Biochar 2 | — | — | 19.0 | — |
| Newspaper | 3.0 | 3.0 | 3.0 | 3.0 |
| Starch | 8.0 | 8.0 | 8.0 | 8.0 |
| Perlite | 19.0 | — | — | 10.0 |
| Total | 100.0 | 100.0 | 100.0 | 100.0 |

Biochar 1 having an average particle size ranging from about 2 mm to about 3 mm. Biochar 2 having an average particle size less than 2 mm.

Each panel was then tested for bulk density, skeletal density, porosity, and strength (modulus). The results are set forth below in Table 2.

TABLE 2

| | Comp. | | | |
|---|---|---|---|---|
| | Ex. 1 | Ex. 1 | Ex. 2 | Ex. 3 |
| Bulk Density (g/cm³) | 0.183 | 0.186 | 0.186 | 0.186 |
| Skeletal Density (g/cm³) | 1.66 | 2.65 | 2.64 | 1.94 |
| Porosity (%) | 89.0 | 93.0 | 92.9 | 90.4 |
| Modulus of Rupture (psi) | 84 | 108 | 111 | 118 |
| Face Ohms | 3.2 | 2.7 | 3.1 | 3.6 |
| Back Ohms | 3.2 | 3.0 | 3.3 | 3.6 |
| Flow Resistivity (Pa*s/m²) | 86,920 | 123,540 | 112,630 | 118,480 |
| Thickness (in) | 0.755 | 0.763 | 0.759 | 0.744 |
| Flow Resistance (Pa*s/m) | 1,667 | 2,394 | 2,171 | 2,239 |

As demonstrated by Table 2, the addition of biochar resulted in a body exhibiting an improvement in strength, evidenced by the increase in modulus of rupture. Surprisingly, there was no material change in bulk density while porosity of the body improved (>90%). Furthermore, the partial/full replacement of perlite in the building panels of Examples 1-3 reflects carbon negative product when compared to that of the building panel of Comparative Example 1.

Therefore, the body of the present invention provides an improvement in panel strength without any degradation in airflow characteristics, thereby allowing the board to maintain its acoustical properties. Without a change in density, the increase in strength results in an acoustical panel translates to superior sag resistance.

### Experiment 2

A second experiment was performed to further test the porosity and carbon reduction of the panels according to the present invention. The panels of Comp. Ex. 2, Ex. 4, and Ex. 5 were formed using water that was recycled from previous board manufacturing. The panels of this experiment each comprised a body formed of a formulation set forth below in Table 3—each amount listed is in weight percentage (wt. %).

TABLE 3

| | Comp. | | |
|---|---|---|---|
| | Ex. 2 | Ex. 4 | Ex. 5 |
| Mineral Wool | 70.0 | 70.0 | 70.0 |
| Biochar | — | 19.0 | 19.0 |
| Newspaper | 3.0 | 3.0 | 3.0 |
| Starch | 8.0 | 8.0 | 8.0 |
| Perlite | 19.0 | — | — |
| Total | 100.0 | 100.0 | 100.0 |

Each panel was then tested for skeletal density, porosity, and global warming potential (“GWP”) based on Kg CO₂/Kg of material. The results are set forth below in Table 4.

TABLE 4

| | Comp. | | |
|---|---|---|---|
| | Ex. 2 | Ex. 4 | Ex. 5 |
| Skeletal Density (g/cm³) | 2.17 | 2.34 | 2.14 |
| Porosity (%) | 90.5 | 91.2 | 90.4 |
| GWP (#CO₂/#Product) | 0.88 | 0.17 | 0.11 |
| GWP (#CO₂/#ft²) | 0.69 | 0.13 | 0.09 |

As demonstrated by Table 4, the addition of biochar resulted in a body with no material change in skeletal density or porosity while the partial/full replacement of perlite in the building panels of Examples 4 and 5 reflects carbon negative product when compared to that of the building panel of Comparative Example 2.

### EXEMPLARY CLAIM SET

Exemplary claim 1. An acoustic building panel comprising: a body comprising: inorganic fiber in an amount ranging from about 60.0 wt. % to about 90.0 wt. % based on the total weight of the body; and biochar in an amount ranging from about 10.0 wt. % to about 40.0 wt. % based on the total weight of the body; wherein the biochar has an average particle size ranging from about 0.1 mm to about 5 mm.

Exemplary claim 2. The acoustic building panel according to Exemplary claim 1, wherein the biochar is present in an amount ranging from about 18 wt. % to about 23 wt. % based on the total weight of the body.

Exemplary claim 3. The acoustic building panel according to any one of Exemplary claims 1 to 2, wherein the inorganic fiber comprises mineral wool.

Exemplary claim 4. The acoustic building panel according to any one of Exemplary claims 1 to 3, wherein the body further comprises an organic fibrous material.

Exemplary claim 5. The acoustic building panel according to Exemplary claim 4, wherein the organic fibrous material is present in an amount ranging from about 1.0 wt. % to about 10.0 wt. % based on the total weight of the body.

Exemplary claim 6. The acoustic building panel according to any one of Exemplary claims 1 to 5, wherein the body further comprises a filler selected from the group consisting of perlite, calcium carbonate, limestone, titanium dioxide, sand, barium sulfate, clay, mica, dolomite, silica, talc, wollastonite, calcite, aluminum trihydrate, pigments, zinc oxide, zinc sulfate, and combinations thereof.

Exemplary claim 7. The acoustic building panel according to any one of Exemplary claims 1 to 6, wherein the body further comprises starch.

Exemplary claim 8. The acoustic building panel according to Exemplary claim 7, wherein the starch is present in an amount ranging from about 5.0 wt. % to about 15.0 wt. % based on the total weight of the body.

Exemplary claim 9. The acoustic building panel according to any one of Exemplary claims 1 to 8, wherein the body has a porosity ranging from about 80% to about 95%.

Exemplary claim 10. The acoustic building panel according to any one of Exemplary claims 1 to 9, wherein the body has a bulk density ranging from about 0.03 g/cm³ to about 0.25 g/cm³.

Exemplary claim 11. The acoustic building panel according to any one of Exemplary claims 1 to 10, wherein the body has a first major surface opposite a second major surface and a side surface extending there between, the body exhibits an airflow resistance ranging from about 200 MKS Rayls to about 40,000 MKS Rayls.

Exemplary claim 12. The acoustic building panel according to any one of Exemplary claims 1 to 11, wherein the body further comprises a flame retardant.

Exemplary claim 13. The acoustic building panel according to Exemplary claim 12, wherein the flame retardant is present in an amount ranging from about 1 wt. % to about 15 wt. % based on the total weight of the body.

Exemplary claim 14. The acoustic building panel according to any one of Exemplary claims 12 to 13, wherein the flame retardant comprises an active filler flame retardant.

Exemplary claim 15. The acoustic building panel according to any one of Exemplary claims 12 to 14, wherein the flame retardant decomposes endothermically.

Exemplary claim 16. The acoustic building panel according to any one of Exemplary claims 12 to 15, wherein the flame retardant decomposes endothermically at an elevated temperature ranging from about 200° C. to about 325° C.

Exemplary claim 17. The acoustic building panel according to any one of Exemplary claims 12 to 16, wherein the flame retardant emits water (H2O) upon decomposition.

Exemplary claim 18. The acoustic building panel according to any one of Exemplary claims 12 to 17, wherein the flame retardant has an average particle size ranging from 1 μm to about 100 μm.

Exemplary claim 19. The acoustic building panel according to any one of Exemplary claims 12 to 18, wherein the flame retardant comprises at least one of colemanite, aluminum hydroxide, magnesium hydroxide, boehmite, hydrous or calcined clay, calcium carbonate, talc, or feldspar.

Exemplary claim 20. An acoustic building panel comprising: a body comprising: inorganic fiber; and biochar; wherein the body has a bulk density ranging from about 0.03 g/cm³ to about 0.25 g/cm³.

Exemplary claim 21. The acoustic building panel according to Exemplary claim 20, wherein the inorganic fiber and the biochar are present in a weight ratio ranging from about 3:1 to about 5:1.

Exemplary claim 22. The acoustic building panel according to Exemplary claim 21, wherein the inorganic fiber and the biochar are present in a weight ratio ranging from about 3.1:1 to about 4.5:1.

Exemplary claim 23. The acoustic building panel according to any one of Exemplary claims 20 to 22, wherein the skeletal density of the body ranges from about 0.35 g/cm³ to about 2.7 g/cm³.

Exemplary claim 24. The acoustic building panel according to any one of Exemplary claims 20 to 23, wherein the inorganic fiber is present in an amount ranging from about 60.0 wt. % to about 90.0 wt. % based on the total weight of the body.

Exemplary claim 25. The acoustic building panel according to any one of Exemplary claims 20 to 24, wherein the biochar in an amount ranging from about 10.0 wt. % to about 40.0 wt. % based on the total weight of the body.

Exemplary claim 26. The acoustic building panel according to any one of Exemplary claims 20 to 25, wherein the inorganic fiber comprises mineral wool.

Exemplary claim 27. The acoustic building panel according to any one of Exemplary claims 20 to 26, wherein the body further comprises a filler selected from the group consisting of perlite, calcium carbonate, limestone, titanium dioxide, sand, barium sulfate, clay, mica, dolomite, silica, talc, wollastonite, calcite, aluminum trihydrate, pigments, zinc oxide, zinc sulfate, and combinations thereof.

Exemplary claim 28. The acoustic building panel according to any one of Exemplary claims 20 to 27, wherein the body further comprises starch.

Exemplary claim 29. The acoustic building panel according to Exemplary claim 28, wherein the starch is present in an amount ranging from about 5.0 wt. % to about 15.0 wt. % based on the total weight of the body.

Exemplary claim 30. The acoustic building panel according to any one of Exemplary claims 20 to 29, wherein the body further comprises an organic fibrous material.

Exemplary claim 31. The acoustic building panel according to Exemplary claim 30, wherein the organic fibrous material is present in an amount ranging from about 1.0 wt. % to about 10.0 wt. % based on the total weight of the body.

Exemplary claim 32. The acoustic building panel according to any one of Exemplary claims 20 to 31, wherein the body has a first major surface opposite a second major surface and a side surface extending there between, the body exhibits an airflow resistance ranging from about 200 MKS Rayls to about 40,000 MKS Rayls.

Exemplary claim 33. The acoustic building panel according to any one of Exemplary claims 20 to 32, wherein the body further comprises a flame retardant.

Exemplary claim 34. The acoustic building panel according to Exemplary claim 33, wherein the flame retardant is present in an amount ranging from about 1 wt. % to about 15 wt. % based on the total weight of the body.

Exemplary claim 35. The acoustic building panel according to any one of Exemplary claims 33 to 34, wherein the flame retardant comprises an active filler flame retardant.

Exemplary claim 36. The acoustic building panel according to any one of Exemplary claims 33 to 35, wherein the flame retardant decomposes endothermically.

Exemplary claim 37. The acoustic building panel according to any one of Exemplary claims 33 to 36, wherein the flame retardant decomposes endothermically at an elevated temperature ranging from about 200° C. to about 325° C.

Exemplary claim 38. The acoustic building panel according to any one of Exemplary claims 33 to 37, wherein the flame retardant emits water (H2O) upon decomposition.

Exemplary claim 39. The acoustic building panel according to any one of Exemplary claims 33 to 38, wherein the flame retardant has an average particle size ranging from about 1 μm to about 100 μm.

Exemplary claim 40. The acoustic building panel according to any one of Exemplary claims 33 to 39, wherein the flame retardant comprises at least one of colemanite, aluminum hydroxide, magnesium hydroxide, boehmite, hydrous or calcined clay, calcium carbonate, talc, or feldspar.

Exemplary claim 41. An acoustic building panel comprising: a body comprising: inorganic fiber; and biochar; wherein the body has a porosity ranging from about 80.0% to about 95.0%.

Exemplary claim 42. The acoustic building panel according to Exemplary claim 41, wherein the inorganic fiber and the biochar are present in a weight ratio ranging from about 3:1 to about 5:1.

Exemplary claim 43. The acoustic building panel according to any one of Exemplary claims 41 to 42, wherein the inorganic fiber is present in an amount ranging from about 60.0 wt. % to about 90.0 wt. % based on the total weight of the body.

Exemplary claim 44. The acoustic building panel according to any one of Exemplary claims 41 to 43, wherein the biochar is present in an amount ranging from about 10.0 wt. % to about 40.0 wt. % based on the total weight of the body.

Exemplary claim 45. The acoustic building panel according to any one of Exemplary claims 41 to 44, wherein the inorganic fiber comprises mineral wool.

Exemplary claim 46. The acoustic building panel according to any one of Exemplary claims 41 to 45, wherein the body further comprises a filler selected from the group consisting of perlite, calcium carbonate, limestone, titanium dioxide, sand, barium sulfate, clay, mica, dolomite, silica, talc, wollastonite, calcite, aluminum trihydrate, pigments, zinc oxide, zinc sulfate, and combinations thereof.

Exemplary claim 47. The acoustic building panel according to Exemplary claim 46, wherein the perlite is present in an amount ranging from about 5.0 wt. % to about 20.0 wt. % based on the total weight of the body.

Exemplary claim 48. The acoustic building panel according to any one of Exemplary claims 41 to 47, wherein the body further comprises starch.

Exemplary claim 49. The acoustic building panel according to Exemplary claim 48, wherein the starch is present in an amount ranging from about 5.0 wt. % to about 15.0 wt. % based on the total weight of the body.

Exemplary claim 50. The acoustic building panel according to any one of Exemplary claims 41 to 49, wherein the body further comprises an organic fibrous material.

Exemplary claim 51. The acoustic building panel according to Exemplary claim 50, wherein the organic fibrous material is present in an amount ranging from about 1.0 wt. % to about 10.0 wt. % based on the total weight of the body.

Exemplary claim 52. The acoustic building panel according to any one of Exemplary claims 41 to 51, wherein the body has a first major surface opposite a second major surface and a side surface extending there between, the body exhibits an airflow resistance ranging from about 200 MKS Rayls to about 40,000 MKS Rayls.

Exemplary claim 53. The acoustic building panel according to any one of Exemplary claims 41 to 52, wherein the body further comprises a flame retardant.

Exemplary claim 54. The acoustic building panel according to Exemplary claim 53, wherein the flame retardant is present in an amount ranging from about 1 wt. % to about 15 wt. % based on the total weight of the body.

Exemplary claim 55. The acoustic building panel according to any one of Exemplary claims 53 to 54, wherein the flame retardant comprises an active filler flame retardant.

Exemplary claim 56. The acoustic building panel according to any one of Exemplary claims 53 to 55, wherein the flame retardant decomposes endothermically.

Exemplary claim 57. The acoustic building panel according to any one of Exemplary claims 53 to 56, wherein the flame retardant decomposes endothermically at an elevated temperature ranging from about 200° C. to about 325° C.

Exemplary claim 58. The acoustic building panel according to any one of Exemplary claims 53 to 57, wherein the flame retardant emits water (H₂O) upon decomposition.

Exemplary claim 59. The acoustic building panel according to any one of Exemplary claims 53 to 58, wherein the flame retardant has an average particle size ranging from about 1 μm to about 100 μm.

Exemplary claim 60. The acoustic building panel according to any one of Exemplary claims 53 to 59, wherein the flame retardant comprises at least one of colemanite, aluminum hydroxide, magnesium hydroxide, boehmite, hydrous or calcined clay, calcium carbonate, talc, or feldspar.

Exemplary claim 61. A ceiling system comprising: a support structure; and at least one of the acoustic building panel according to anyone of Exemplary claims 1 to 60 mounted to the support structure.

Exemplary claim 62. A method of manufacturing an acoustic building panel comprising: mixing a liquid carrier, inorganic fiber, biochar, and a binder to form a blend; and shaping and drying the blend into a body having a first major surface opposite a second major surface and side surfaces extending between the first and second major surface, wherein the body is substantially free of the liquid carrier.

Exemplary claim 63. The method according to Exemplary claim 62, wherein the blend further comprises a filler selected from the group consisting of perlite, calcium carbonate, limestone, titanium dioxide, sand, barium sulfate, clay, mica, dolomite, silica, talc, wollastonite, calcite, aluminum trihydrate, pigments, zinc oxide, zinc sulfate, and combinations thereof.

Exemplary claim 64. The method according to any one of Exemplary claims 62 to 63, wherein the blend further comprises an organic fibrous material.

Exemplary claim 65. The method according to any one of Exemplary claims 62 to 64, wherein the biochar has an average particle size ranging from about 0.1 mm to about 5 mm.

Exemplary claim 66. The method according to any one of Exemplary claims 62 to 65, wherein the inorganic fiber and the biochar are present in the blend in a weight ratio ranging from about 3:1 to about 5:1.

Exemplary claim 67. The method according to any one of Exemplary claims 62 to 66, wherein the body has a porosity ranging from about 80.0% to about 95.0%.

Exemplary claim 68. The method according to any one of Exemplary claims 62 to 67, wherein the blend further comprises a flocculant.

Exemplary claim 69. The method according to any one of Exemplary claims 62 to 68, wherein the blend further comprises a flame retardant.

Exemplary claim 70. The method according to Exemplary claim 69, wherein the flame retardant is present in an amount ranging from about 1 wt. % to about 15 wt. % based on the total weight of the body.

Exemplary claim 71. The method according to any one of Exemplary claims 69 to 70, wherein the flame retardant comprises an active filler flame retardant.

Exemplary claim 72. The method according to any one of Exemplary claims 69 to 71, wherein the flame retardant decomposes endothermically.

Exemplary claim 73. The method according to any one of Exemplary claims 69 to 72, wherein the flame retardant decomposes endothermically at an elevated temperature ranging from about 200° C. to about 325° C.

Exemplary claim 74. The method according to any one of Exemplary claims 69 to 73, wherein the flame retardant emits water (H2O) upon decomposition.

Exemplary claim 75. The method according to any one of Exemplary claims 69 to 74, wherein the flame retardant has an average particle size ranging from about 1 μm to about 100 μm.

Exemplary claim 76. The method according to any one of Exemplary claims 69 to 75, wherein the flame retardant comprises at least one of colemanite, aluminum hydroxide, magnesium hydroxide, boehmite, hydrous or calcined clay, calcium carbonate, talc, or feldspar.

Exemplary claim 77. An acoustic building panel comprising: a body comprising: inorganic fiber in an amount ranging from about 60.0 wt. % to about 90.0 wt. % based on the total weight of the body; biochar ranging in an amount from about 10.0 wt. % to about 40.0 wt. % based on the total weight of the body; and a flame retardant.

Exemplary claim 78. The acoustic building panel according to Exemplary claim 77, wherein the flame retardant is present in an amount ranging from about 1 wt. % to about 15 wt. % based on the total weight of the body.

Exemplary claim 79. The acoustic building panel according to any one of Exemplary claims 77 to 78, wherein the flame retardant comprises an active filler flame retardant.

Exemplary claim 80. The acoustic building panel according to any one of Exemplary claims 77 to 79, wherein the flame retardant decomposes endothermically.

Exemplary claim 81. The acoustic building panel according to any one of Exemplary claims 77 to 80, wherein the flame retardant decomposes endothermically at an elevated temperature ranging from about 200° C. to about 325° C.

Exemplary claim 82. The acoustic building panel according to any one of Exemplary claims 77 to 81, wherein the flame retardant emits water (H₂O) upon decomposition.

Exemplary claim 83. The acoustic building panel according to any one of Exemplary claims 77 to 82, wherein the flame retardant comprises at least one of colemanite, aluminum hydroxide, magnesium hydroxide, boehmite, hydrous or calcined clay, calcium carbonate, talc, or feldspar.

Exemplary claim 84. The acoustic building panel according to any one of Exemplary claims 77 to 83, wherein the flame retardant has an average particle size ranging from about 1 μm to about 100 μm.

Exemplary claim 85. The acoustic building panel according to any one of Exemplary claims 77 to 84, wherein the biochar has an average particle size ranging from about 0.1 mm to about 5 mm.

Exemplary claim 86. The acoustic building panel according to any one of Exemplary claims 77 to 85, wherein the body further comprises a filler.

Exemplary claim 87. The acoustic building panel according to Exemplary claim 86, wherein the filler is present in an amount ranging from about 5.0 wt. % to about 20.0 wt. % based on the total weight of the body.

Exemplary claim 88. The acoustic building panel according to any one of Exemplary claims 86 to 87, wherein the filler comprises at least one of perlite, calcium carbonate, limestone, titanium dioxide, sand, barium sulfate, clay, mica, dolomite, silica, talc, wollastonite, calcite, aluminum trihydrate, pigments, zinc oxide, or zinc sulfate.

Exemplary claim 89. The acoustic building panel according to any one of Exemplary claims 77 to 88, wherein the inorganic fiber comprises at least one of mineral wool, rock wool, stone wool, glass fibers, or polymer fibers.

Exemplary claim 90. The acoustic building panel according to any one of Exemplary claims 77 to 89, wherein the body further comprises an organic fibrous material.

Exemplary claim 91: The acoustic building panel according to Exemplary claim 90, wherein the organic fibrous material is present in an amount ranging from about 1 wt. % to about 10 wt. % based on the total weight of the body.

Exemplary claim 92. The acoustic building panel according to any one of Exemplary claims 90 to 91, wherein the organic fibrous material comprises at least one of macroscopic cellulosic fibers or protein fibers.

Exemplary claim 93. The acoustic building panel according to any one of Exemplary claims 77 to 92, wherein the body further comprises a binder.

Exemplary claim 94: The acoustic building panel according to Exemplary claim 93, wherein the binder is present in an amount ranging from about 1 wt. % to about 20 wt. % based on the total weight of the body.

Exemplary claim 95. The acoustic building panel according to any one of Exemplary claims 93 to 94, wherein the binder comprises at least one of a starch-based polymer, polyvinyl alcohol (PVOH), a latex, a polysaccharide polymer, a cellulosic polymer, a protein solution polymer, an acrylic polymer, polymaleic anhydride, or an epoxy resin.

Exemplary claim 96. The acoustic building panel according to any one of Exemplary claims 93 to 95, wherein the binder comprises starch.

Exemplary claim 97. The acoustic building panel according to any one of Exemplary claims 77 to 96, wherein the body has a porosity ranging from about 80% to about 95%.

Exemplary claim 98. The acoustic building panel according to any one of Exemplary claims 77 to 97, wherein the body has a bulk density ranging from about 0.03 g/cm³ to about 0.25 g/cm³.

Exemplary claim 99. The acoustic building panel according to any one of Exemplary claims 77 to 98, wherein the skeletal density of the body ranges from about 0.35 g/cm³ to about 2.7 g/cm³.

Exemplary claim 100. The acoustic building panel according to any one of Exemplary claims 77 to 98, wherein the body has a first major surface opposite a second major surface and a side surface extending there between, the body exhibits an airflow resistance ranging from about 200 MKS Rayls to about 40,000 MKS Rayls.

Exemplary claim 101. A ceiling system comprising: a support structure; and at least one of the acoustic building panel according to anyone of Exemplary claims 77 to 100 mounted to the support structure.

Exemplary claim 102. A method of manufacturing an acoustic building panel comprising: mixing a liquid carrier, inorganic fiber, biochar, a flame retardant, and a binder to form a blend; and shaping and drying the blend into a body having a first major surface opposite a second major surface and side surfaces extending between the first and second major surface, wherein the body is substantially free of the liquid carrier.

Exemplary claim 103. The method according to Exemplary claim 102, wherein the flame retardant is present in an amount ranging from about 1 wt. % to about 15 wt. % based on the total weight of the body.

Exemplary claim 104. The method according to any one of Exemplary claims 102 to 103, wherein the flame retardant comprises an active filler flame retardant.

Exemplary claim 105. The method according to Exemplary claim 104, wherein the active filler flame retardant decomposes endothermically.

Exemplary claim 106. The method according to Exemplary claim 105, wherein the active filler flame retardant decomposes endothermically at an elevated temperature ranging from about 200° C. to about 325° C.

Exemplary claim 107. The method according to any one of Exemplary claims 105 to 106, wherein the active filler flame retardant emits water (H2O) upon decomposition.

Exemplary claim 108. The method according to any one of Exemplary claims 102 to 107, wherein the active filler flame retardant has an average particle size ranging from about 1 μm to about 100 μm.

Exemplary claim 109. The method according to any one of Exemplary claims 102 to 108, wherein the active filler flame retardant comprises at least one of colemanite, aluminum hydroxide, magnesium hydroxide, boehmite, hydrous or calcined clay, calcium carbonate, talc, or feldspar.

Exemplary claim 110. The method according to any one of Exemplary claims 102 to 109, wherein the biochar has an average particle size ranging from about 0.1 mm to about 5 mm.

Exemplary claim 111. The method according to any one of Exemplary claims 102 to 110, wherein the blend further comprises a filler.

Exemplary claim 112. The method according to Exemplary claim 111, wherein the filler is present in an amount ranging from about 5.0 wt. % to about 20.0 wt. % based on the total weight of the body.

Exemplary claim 113. The method according to any one of Exemplary claims 111 to 112, wherein the filler comprises at least one of perlite, calcium carbonate, limestone, titanium dioxide, sand, barium sulfate, clay, mica, dolomite, silica, talc, wollastonite, calcite, aluminum trihydrate, pigments, zinc oxide, or zinc sulfate.

Exemplary claim 114. The method according to any one of Exemplary claims 102 to 113, wherein the inorganic fiber comprises at least one of mineral wool, rock wool, stone wool, glass fibers, or polymer fibers.

Exemplary claim 115. The method according to any one of Exemplary claims 102 to 111, wherein the blend further comprises an organic fibrous material.

Exemplary claim 116. The method according to Exemplary claim 115, wherein the organic fibrous material is present in an amount ranging from about 1 wt. % to about 10 wt. % based on the total weight of the body.

Exemplary claim 117. The method according to any one of Exemplary claims 115 to 116, wherein the organic fibrous material comprises at least one of macroscopic cellulosic fibers or protein fibers.

Exemplary claim 118. The method according to any one of Exemplary claims 102 to 117, wherein the binder is present in an amount ranging from about 1 wt. % to about 20 wt. % based on the total weight of the body.

Exemplary claim 119. The method according to any one of Exemplary claims 102 to 118, wherein the binder comprises at least one of a starch-based polymer, polyvinyl alcohol (PVOH), a latex, a polysaccharide polymer, a cellulosic polymer, a protein solution polymer, an acrylic polymer, polymaleic anhydride, or an epoxy resin.

Exemplary claim 120. The method according to any one of Exemplary claims 102 to 119, wherein the binder comprises starch.

Exemplary claim 121. The method according to any one of Exemplary claims 102 to 120, wherein the blend further comprises a flocculant.

Exemplary claim 122. The method according to any one of Exemplary claims 102 to 121, wherein the liquid carrier comprises water.

Exemplary claim 123. The method according to any one of Exemplary claims 102 to 122, wherein the body has a porosity ranging from about 80% to about 95%.

Exemplary claim 124. The method according to any one of Exemplary claims 102 to 123, wherein the body has a bulk density ranging from about 0.03 g/cm³ to about 0.25 g/cm³.

Exemplary claim 125. The method according to any one of Exemplary claims 102 to 124, wherein the skeletal density of the body ranges from about 0.35 g/cm³ to about 2.7 g/cm³.

Exemplary claim 126. The method according to any one of Exemplary claims 102 to 125, wherein the body has a first major surface opposite a second major surface and a side surface extending there between, the body exhibits an airflow resistance ranging from about 200 MKS Rayls to about 40,000 MKS Rayls.

Exemplary claim 127. A building panel comprising: a body comprising: an inorganic material in an amount ranging from about 1 wt. % to about 99 wt. % based on the total weight of the body, wherein the inorganic material comprises an alkaline earth metal compound; biochar in an amount ranging from about 1 wt. % to about 40 wt. % based on the total weight of the body; and a flame retardant in an amount ranging from about 1 wt. % to about 15 wt. % based on the total weight of the body, wherein the flame retardant comprises an active filler flame retardant.

Exemplary claim 128. The building panel according to Exemplary claim 127, wherein the alkaline earth metal compound comprises at least one of a calcium compound or a magnesium compound.

Exemplary claim 129. The building panel according to any one of Exemplary claims 127 to 128, wherein the alkaline earth metal compound comprises at least one of an alkaline earth metal oxide or an alkaline earth metal sulfate.

Exemplary claim 130. The building panel according to any one of Exemplary claims 127 to 129, wherein the alkaline earth metal compound comprises at least one of calcium sulfate, magnesium sulfate, or magnesium oxide.

Exemplary claim 131. The building panel according to any one of Exemplary claims 127 to 130, wherein the inorganic material comprises inorganic particles having an average particle size ranging from about 0.1 μm to about 5 mm.

Exemplary claim 132: The building panel according to any one of Exemplary claims 127 to 131, wherein the flame retardant decomposes endothermically.

Exemplary claim 133. The building panel according to any one of Exemplary claims 127 to 132, wherein the flame retardant decomposes endothermically at an elevated temperature ranging from about 200° C. to about 325° C.

Exemplary claim 134. The building panel according to any one of Exemplary claims 127 to 133, wherein the flame retardant emits water (H2O) upon decomposition.

Exemplary claim 135. The building panel according to any one of Exemplary claims 127 to 134, wherein the flame retardant comprises at least one of colemanite, aluminum hydroxide, magnesium hydroxide, boehmite, hydrous or calcined clay, calcium carbonate, talc, or feldspar.

Exemplary claim 136. The building panel according to any one of Exemplary claims 127 to 135, wherein the flame retardant has an average particle size ranging from about 1 μm to about 100 μm.

Exemplary claim 137. The building panel according to any one of Exemplary claims 127 to 136, wherein the biochar has an average particle size ranging from about 0.1 mm to about 5 mm.

Exemplary claim 138. The building panel according to any one of Exemplary claims 127 to 137, wherein the biochar has a density ranging from about 3 pcf to about 18 pcf.

Exemplary claim 139. The building panel according to any one of Exemplary claims 127 to 138, wherein the inorganic material and the biochar are present in a weight ratio ranging from about 1.5:1 to about 6:1, optionally from about 2:1 to about 4:1, or optionally from about 2.5:1 to about 3.5:1.

Exemplary claim 140. The building panel according to any one of Exemplary claims 127 to 139, wherein the inorganic material and the flame retardant are present in a weight ratio ranging from about 3:1 to about 12:1, optionally from about 4:1 to about 8:1, or optionally from about 5:1 to about 7:1.

Exemplary claim 141. The building panel according to any one of Exemplary claims 127 to 140, wherein the biochar and the flame retardant are present in a weight ratio ranging from about 1:1 to about 20:1, optionally from about 1.5:1 to about 4:1.

Exemplary claim 142. The building panel according to any one of Exemplary claims 127 to 141, wherein the body exhibits an NRC value ranging from about 0.6 to about 0.99.

Exemplary claim 143. The building panel according to any one of Exemplary claims 127 to 142, wherein the body comprises a first major surface opposite a second major surface and a plurality of perforations extending from the first major surface to the second major surface of the body.

Exemplary claim 144. The building panel according to Exemplary claim 143, wherein the plurality of perforations has an average diameter ranging from about 0.5 mm to about 100 mm.

Exemplary claim 145. The building panel according to any one of Exemplary claims 143 to 144, wherein the plurality of perforations is present in a perforation density ranging from about 1 perforation/ft2 to about 100 perforation/ft2.

Exemplary claim 146. The building panel according to any one of Exemplary claims 143 to 145, wherein the body exhibits an airflow resistance ranging from about 200 MKS Rayls to about 40,000 MKS Rayls as measured between the first major surface and the second major surface.

Exemplary claim 147. The building panel according to any one of Exemplary claims 143 to 146, wherein the body has a bulk density ranging from about 0.03 g/cm³ to about 0.25 g/cm³.

Exemplary claim 148. The building panel according to any one of Exemplary claims 143 to 147, wherein the skeletal density of the body ranges from about 1 g/cm³ to about 2.6 g/cm³.

Exemplary claim 149. A ceiling system comprising: a support structure; and at least one of the building panel according to anyone of Exemplary claims 127 to 148 mounted to the support structure.

Exemplary claim 150. A method of manufacturing a building panel comprising: mixing an inorganic material, biochar, a flame retardant, and a liquid carrier to form a blend; and shaping and hardening the blend into a body having a first major surface opposite a second major surface and side surfaces extending between the first and second major surface; wherein, the inorganic material comprises an alkaline earth metal compound; the flame retardant comprises an active filler flame retardant; the inorganic material is present in an amount ranging from about 1 wt. % to about 99 wt. % based on the total weight of the hardened body; the biochar is present in an amount ranging from about 10 wt. % to about 40 wt. % based on the total weight of the hardened body; and the flame retardant is present in an amount ranging from about 1 wt. % to about 15 wt. % based on the total weight of the hardened body.

Exemplary claim 151. The method according to Exemplary claim 150, wherein the alkaline earth metal compound comprises at least one of a calcium compound or a magnesium compound.

Exemplary claim 152. The method according to any one of Exemplary claims 150 to 151, wherein the alkaline earth metal compound comprises at least one of an alkaline earth metal oxide or an alkaline earth metal sulfate.

Exemplary claim 153. The method according to any one of Exemplary claims 150 to 152, wherein the alkaline earth metal compound comprises at least one of calcium sulfate, magnesium sulfate, or magnesium oxide.

Exemplary claim 154. The method according to any one of Exemplary claims 150 to 153, wherein the inorganic material comprises inorganic particles having an average particle size ranging from about 0.1 μm to about 5 mm.

Exemplary claim 155. The method according to any one of Exemplary claims 150 to 154, wherein the flame retardant decomposes endothermically.

Exemplary claim 156. The method according to any one of Exemplary claims 150 to 155, wherein the flame retardant decomposes endothermically at an elevated temperature ranging from about 200° C. to about 325° C.

Exemplary claim 157. The method according to any one of Exemplary claims 150 to 156, wherein the flame retardant emits water (H2O) upon decomposition.

Exemplary claim 158. The method according to any one of Exemplary claims 150 to 157, wherein the flame retardant comprises at least one of colemanite, aluminum hydroxide, magnesium hydroxide, boehmite, hydrous or calcined clay, calcium carbonate, talc, or feldspar.

Exemplary claim 159. The method according to any one of Exemplary claims 150 to 158, wherein the flame retardant has an average particle size ranging from about 1 μm to about 100 μm.

Exemplary claim 160. The method according to any one of Exemplary claims 150 to 159, wherein the biochar has an average particle size ranging from about 0.1 mm to about 5 mm.

Exemplary claim 161. The method according to any one of Exemplary claims 150 to 160, wherein the biochar has a density ranging from about 3 pcf to about 18 pcf.

Exemplary claim 162. The method according to any one of Exemplary claims 150 to 161, wherein the inorganic material and the biochar are present in a weight ratio ranging from about 1.5:1 to about 6:1, optionally from about 2:1 to about 4:1, or optionally from about 2.5:1 to about 3.5:1.

Exemplary claim 163. The method according to any one of Exemplary claims 150 to 162, wherein the inorganic material and the flame retardant are present in a weight ratio ranging from about 3:1 to about 12:1, optionally from about 4:1 to about 8:1, or optionally from about 5:1 to about 7:1.

Exemplary claim 164. The method according to any one of Exemplary claims 150 to 163, wherein the biochar and the flame retardant are present in a weight ratio ranging about 1:1 to about 20:1, optionally from about 1.5:1 to about 4:1.

Exemplary claim 165. The method according to any one of Exemplary claims 150 to 164, wherein the body exhibits an NRC value ranging from about 0.6 to about 0.99.

Exemplary claim 166. The method according to any one of Exemplary claims 150 to 165, further comprising forming a plurality of perforations extending from the first major surface to the second major surface of the body.

Exemplary claim 167. The method according to Exemplary claim 166, wherein the plurality of perforations has an average diameter ranging from about 0.5 mm to about 100 mm.

Exemplary claim 168. The method according to any one of Exemplary claims 166 to 167, wherein the plurality of perforations is present in a perforation density ranging from about 1 perforation/ft2 to about 100 perforation/ft2.

Exemplary claim 169. The method according to any one of Exemplary claims 166 to 168, wherein the body exhibits an airflow resistance ranging from about 200 MKS Rayls to about 40,000 MKS Rayls as measured between the first major surface and the second major surface.

Exemplary claim 170. The method according to any one of Exemplary claims 166 to 169, wherein the body has a bulk density ranging from about 0.03 g/cm³ to about 0.25 g/cm³.

Exemplary claim 171. The method according to any one of Exemplary claims 166 to 170, wherein the skeletal density of the body ranges from about 1 g/cm³ to about 2.6 g/cm³.

Exemplary claim 172. The method according to any one of Exemplary claims 166 to 171, wherein the liquid carrier comprises water.

Exemplary claim 173. A building panel comprising: a body comprising: an inorganic material in an amount ranging from about 1 wt. % to about 99 wt. % based on the total weight of the body; biochar in an amount ranging from about 1 wt. % to about 40 wt. % based on the total weight of the body; and a flame retardant in an amount ranging from about 1 wt. % to about 15 wt. % based on the total weight of the body, wherein the flame retardant comprises an active filler flame retardant.

Exemplary claim 174. The building panel according to Exemplary claim 173, wherein the inorganic material comprises an alkaline earth metal compound.

Exemplary claim 175. The building panel according to Exemplary claim 174, wherein the alkaline earth metal compound comprises at least one of a calcium compound or a magnesium compound.

Exemplary claim 176. The building panel according to any one of Exemplary claims 174 to 175, wherein the alkaline earth metal compound comprises at least one of an alkaline earth metal oxide or an alkaline earth metal sulfate.

Exemplary claim 177. The building panel according to any one of Exemplary claims 174 to 176, wherein the alkaline earth metal compound comprises at least one of calcium sulfate, magnesium sulfate, or magnesium oxide.

Exemplary claim 178. The building panel according to Exemplary claim 173, wherein the inorganic material comprises inorganic fiber.

Exemplary claim 179. The building panel according to Exemplary claim 178, wherein the inorganic fiber is present in an amount ranging from about 60.0 wt. % to about 90.0 wt. % based on the total weight of the body.

Exemplary claim 180. The building panel according to any one of Exemplary claims 178 to 179, wherein the inorganic fiber comprises mineral wool.

Exemplary claim 181. The building panel according to any one of Exemplary claims 173 to 180, wherein the flame retardant decomposes endothermically.

Exemplary claim 182. The building panel according to any one of Exemplary claims 173 to 181, wherein the flame retardant decomposes endothermically at an elevated temperature ranging from about 200° C. to about 325° C.

Exemplary claim 183. The building panel according to any one of Exemplary claims 173 to 182, wherein the flame retardant emits water (H2O) upon decomposition.

Exemplary claim 184. The building panel according to any one of Exemplary claims 173 to 183, wherein the flame retardant has an average particle size ranging from 1 μm to about 100 μm.

Exemplary claim 185. The building panel according to any one of Exemplary claims 173 to 184, wherein the flame retardant comprises at least one of colemanite, aluminum hydroxide, magnesium hydroxide, boehmite, hydrous or calcined clay, calcium carbonate, talc, or feldspar.

1. An acoustic building panel comprising:
a body comprising:
inorganic fiber in an amount ranging from about 60.0 wt. % to about 90.0 wt. % based on the total weight of the body; and
biochar in an amount ranging from about 10.0 wt. % to about 40.0 wt. % based on the total weight of the body;
wherein the biochar has an average particle size ranging from about 0.1 mm to about 5 mm.

2-4. (canceled)

5. The acoustic building panel according to claim 1, wherein the body further comprises a flame retardant.

6-7. (canceled)

8. A building panel comprising:
a body comprising:
an inorganic material in an amount ranging from about 1 wt. % to about 99 wt. % based on the total weight of the body, wherein the inorganic material comprises an alkaline earth metal compound;
biochar in an amount ranging from about 1 wt. % to about 40 wt. % based on the total weight of the body; and
a flame retardant in an amount ranging from about 1 wt. % to about 15 wt. % based on the total weight of the body, wherein the flame retardant comprises an active filler flame retardant.

9. A method of manufacturing a building panel comprising:
mixing an inorganic material, biochar, a flame retardant, and a liquid carrier to form a blend; and
shaping and hardening the blend into a body having a first major surface opposite a second major surface and side surfaces extending between the first and second major surface;
wherein:
the inorganic material comprises an alkaline earth metal compound;
the flame retardant comprises an active filler flame retardant;
the inorganic material is present in an amount ranging from about 1 wt. % to about 99 wt. % based on the total weight of the hardened body;
the biochar is present in an amount ranging from about 10 wt. % to about 40 wt. % based on the total weight of the hardened body; and
the flame retardant is present in an amount ranging from about 1 wt. % to about 15 wt. % based on the total weight of the hardened body.

10. (canceled)

11. The acoustic building panel according to claim 1, wherein the biochar is present in an amount ranging from about 18 wt. % to about 23 wt. % based on the total weight of the body.

12. The acoustic building panel according to claim 1, wherein the inorganic fiber comprises mineral wool.

13. The acoustic building panel according to claim 1, wherein the body further comprises an organic fibrous material present in an amount ranging from about 1.0 wt. % to about 10.0 wt. % based on the total weight of the body.

14. (canceled)

15. The acoustic building panel according to claim 1, wherein the body has a bulk density ranging from about 0.03 g/cm³ to about 0.25 g/cm³.

16. The acoustic building panel according to claim 1, wherein the body has a first major surface opposite a second major surface and a side surface extending there between, the body exhibits an airflow resistance ranging from about 200 MKS Rayls to about 40,000 MKS Rayls.

17. The acoustic building panel according to claim 5, wherein the flame retardant is present in an amount ranging from about 1 wt. % to about 15 wt. % based on the total weight of the body.

18. The acoustic building panel according to claim 5, wherein the flame retardant comprises an active filler flame retardant.

19. (canceled)

20. The acoustic building panel according to claim 5, wherein the flame retardant decomposes endothermically at an elevated temperature ranging from about 200° C. to about 325° C.

21. The acoustic building panel according to claim 5, wherein the flame retardant emits water (H₂O) upon decomposition.

22. The acoustic building panel according to claim 5, wherein the flame retardant has an average particle size ranging from 1 μm to about 100 μm.

23. The acoustic building panel according to claim 5, wherein the flame retardant comprises at least one of colemanite, aluminum hydroxide, magnesium hydroxide, boehmite, hydrous or calcined clay, calcium carbonate, talc, or feldspar.

24. The building panel according to claim 8, wherein the alkaline earth metal compound comprises at least one of a calcium compound or a magnesium compound, optionally wherein the alkaline earth metal compound comprises at least one of an alkaline earth metal oxide or an alkaline earth metal sulfate, optionally wherein the alkaline earth metal compound comprises at least one of calcium sulfate, magnesium sulfate, or magnesium oxide and optionally wherein the inorganic material comprises inorganic particles having an average particle size ranging from about 0.1 μm to about 5 mm.

25. (canceled)

26. The acoustic building panel according to claim 1, wherein the body has a bulk density ranging from about 0.03 g/cm³ to about 0.25 g/cm³.

27. The acoustic building panel according to claim 1, wherein the body has a porosity ranging from about 80.0% to about 95.0%.

28. The building panel according to claim 1, wherein the body further comprises a filler selected from the group consisting of perlite, calcium carbonate, limestone, titanium dioxide, sand, barium sulfate, clay, mica, dolomite, silica, talc, wollastonite, calcite, aluminum trihydrate, pigments, zinc oxide, zinc sulfate, and combinations thereof.

29. The building panel according to claim 8, wherein the flame retardant decomposes endothermically at an elevated temperature ranging from about 200° C. to about 325° C.
